(19) United States
(12) Patent Application Publication
(10) Pub. No.: US 2004/0120039 A1
(43) Pub. Date: Jun. 24, 2004

(54) Three-dimensional image display device, polarization means position holding mechanism, and polarization means

(75) Inventors: Seiji Sato, Kanagawa (JP); Hidehiko Sekizawa, Tokyo (JP)

Correspondence Address: Randy J. Pritzker, Wolf, Greenfield & Sacks, P.C., 600 Atlantic Avenue, Boston, MA, 02210, US

(73) Assignee: Sony Corporation, Tokyo (JP)

(21) Appl. No.: 10/656,843

(22) Filed: Sep. 5, 2003

(30) Foreign Application Priority Data
Sep. 6, 2002 (JP) JP2002-261484
Oct. 29, 2002 (JP) JP2002-313655

(51) Int. Cl. G09G 5/00; G02B 27/26

(52) U.S. Cl. 359/465

(57) ABSTRACT

Disclosed herein is a three-dimensional image display device having an image display portion for displaying image information according to a parallax separately in a first segment and a second segment, a separate wave plate filter opposed to the first and second segments of the image display portion for converting a polarization direction of polarized light of the image information from the first segment into a direction different from a polarization direction of polarized light of the image information from the second segment, and a polarization plate having a first portion and a second portion to which the polarized lights separated by the separate wave plate filter are respectively input. The three-dimensional image display device further has a polarization plate holder for holding the positional relation between the polarization plate and the separate wave plate filter. Accordingly, a clear three-dimensional image can be always observed relatively easily, accurately, and quickly.

### BACKGROUND OF THE INVENTION

The present invention relates to a three-dimensional (3D) image display device suitable for observation of 3D image information, a polarization means position holding mechanism for use with the 3D image display device, and polarization means adapted to be mounted to the position holding mechanism.

Various attempts have conventionally been made on a technique for representing a 3D image, and a 3D image displaying method has been researched and becoming into practical use in many fields handling images in photograph, movie, television, etc.

Such a 3D image displaying method is generally classified into a spectacles wearing type and a spectacles unwearing type. In any method, an image with a parallax is separately input into the right and left eyes of an observer to thereby allow 3D vision. Typical examples of the spectacles wearing type include an anaglyph method using a pair of spectacles with red and blue filters respectively for the observer's eyes, and a polarization spectacles wearing method.

Such an anaglyph method as a color separation method has many disadvantages in quality such as difficulty of color representation and degradation in field of view. On the other hand, the polarization spectacles wearing method had a problem such that two projectors are generally required. However, there has recently been proposed a direct-view type single image display device using polarization spectacles which allows the display of a 3D image.

FIG. 18 schematically shows such a 3D image display device 65 using polarization spectacles.

The 3D image display device 65 is generally composed of a liquid crystal panel 59 and a separate wave plate filter 64 mounted on the liquid crystal panel 59. The liquid crystal panel 59 includes a polarization plate 106 having a polarization angle indicated by the lines inclined upward to the left, a polarization plate 96 having a polarization angle indicated by the lines inclined upward to the right, a pair of transparent support substrates 74a and 74b interposed between the polarization plates 106 and 96, and a liquid crystal image display portion 75 interposed between the transparent support substrates 74a and 74b. The liquid crystal image display portion 75 has a plurality of sets of pixel portions 78R (red), 78G (green), and 78B (blue).

The separate wave plate filter 64 is provided on the front side of the liquid crystal panel 59, and it is composed of a transparent support substrate 74c and a plurality of separate wave plates (half-wave plates) 76 for conversion of a polarization direction, provided on one surface (back surface) of the transparent support substrate 74c. The separate wave plates 76 are arrayed at intervals of one horizontal pixel line of the image display portion 75. Although only several horizontal pixel lines are shown for simplicity of illustration, many horizontal pixel lines are arranged in actual (ditto for the following examples). The separate wave plate filter 64 is referred to also as a micropol or micropolarizer.

According to the 3D image display device 65 shown in FIG. 18, the polarization direction of linearly polarized light output from the liquid crystal panel 59 is rotated 90° by the operation of the separate wave plate filter 64, thereby converting the polarization direction of linearly polarized light output from the odd or even pixel lines of the image display portion 75 into a direction perpendicular to the polarization direction of linearly polarized light output from the even or odd pixel lines.

For example, the polarization direction of linearly polarized light from the odd pixel lines of the liquid crystal panel 59 is not converted by the separate wave plates 76 of the separate wave plate filter 64, but the polarization direction of linearly polarized light from the even pixel lines of the liquid crystal panel 59 is converted into a direction perpendicular to the polarization direction of linearly polarized light from the odd pixel lines by the separate wave plates 76.

These linearly polarized lights having perpendicular polarization directions are observed through a polarization plate 69 (e.g., polarization spectacles) located in the vicinity of the observer's eyes. The polarization plate 69 has a right portion 57R having a polarization angle indicated by the lines inclined upward to the right and a left portion 57L having a polarization angle indicated by the lines inclined upward to the left in perpendicular relationship with the polarization angle of the right portion 57R. The polarized light of a right-eye image from the liquid crystal panel 59 enters the right eye 72R of the observer, and the polarized light of a left-eye image from the liquid crystal panel 59 enters the left eye 72L of the observer. Thus, the right-eye and left-eye images are observed through the polarization plate 69 by the right and left eyes 72R and 72L of the observer, so that the observer can observe a full-color 3D image with no flicker.

However, in mounting the separate wave plate filter 64 on the liquid crystal panel 59 to construct the 3D image display device 65, the separate wave plate filter 64 must be reliably fixed in position so as to correspond to a given region (pixel position) in the liquid crystal panel 59. However, this positioning is difficult to cause the following problems.

First, the image displaying method by the above image display device 65 is such that the image display portion 75 is divided into given regions, so that it is necessary to make each region finer for an increased resolution.

In response to recent requirement for higher resolution of an image, a pixel region on an image display surface is becoming finer. Accordingly, the liquid crystal panel 59 having a high-resolution image display surface with finely divided pixel region is available. However, it is very difficult to fabricate the separate wave plate filter 64 having a finely separated pattern corresponding to the finely divided pixel region in an independent process and to precisely mount the separate wave plate filter 64 on the image display surface so that the separated pattern of the filter 64 is aligned to the divided pattern (i.e., given pixel region) of the image display surface.

Even if the separate wave plate filter 64 is precisely mounted on the image display surface, there arises a problem that the filter 64 may be displaced during a time period of curing of resin for bonding the filter 64 to the image display surface after adjustment of the position of the filter 64. Further, such displacement of the filter 64 may be caused by other factors such as vibrations and heat during transportation.

In many cases, the transparent support substrate 74c of the separate wave plate filter 64 is generally formed from a heavy glass substrate from the viewpoints of positioning accuracy in mounting the filter 64 at a given region and of fabrication. Accordingly, the displacement of the filter 64 due to its own weight is prone to occur. Further, the displacement of the filter 64 may also be caused by a reduction in durability such as a deterioration of the bonding material for bonding the filter 64 to the image display portion. When the bonding material once cured is displaced, it is very difficult to subsequently correct the displacement of the bonding material, causing a possibility that the relatively high-cost liquid crystal panel 59 may become unusable and wasteful.

Further, while the optimum position of the separate wave plate filter 64 must be decided in observing a 3D image also according to the observer-related conditions such as the position and height of the observer's eyes, the position of the filter 64 prefixed to the image display portion does not necessarily become an optimum position in observing a 3D image.

If the separate wave plate filter 64 is displaced relative to the image display portion 75 by several % to tens of % (e.g., tens of μm) because of the above factors, the displacement of the filter 64 causes partial mixing of optical information between the pixel portions 78R, 78G, and 78B, resulting in crosstalk. The crosstalk is then amplified in observing a 3D image.

When the separate wave plate filter 64 is placed in a proper position, the lights from the pixel portions 78R, 78G, and 78B are always passed through the corresponding separate wave plates 76 and through the gaps therebetween, and these lights passed through the separate wave plates 76 and through the gaps therebetween do not interfere with each other.

However, if the separate wave plate filter 64 is displaced from the proper position even by such a slight amount that the proportion of the displacement is several % to tens of % of the size of the pixel portions 78R, 78G, and 78B and the absolute amount of the displacement is about 50 μm, the vertical displacement between the opposite side edges of the liquid crystal panel 59 becomes larger. As a result, there is a possibility that the lights from the pixel portions 78R, 78G, and 78B may not always be passed through the corresponding wave plates 76 and through the gaps therebetween.

As a result, crosstalk occurs between the pixel portions 78R, 78G, and 78G (between the adjacent lines of the pixel portions 78R, 78G, and 78B), and a good 3D image cannot be displayed.

To solve the above problems, the present applicant has already proposed a 3D image display device as described below in Japanese Patent Application No. 2001-247779 (which device will be hereinafter referred to as a related 3D image display device). The structure of this related 3D image display device will now be described with reference to FIG. 19.

As shown in FIG. 19, the related 3D image display device includes a notebook computer 60 having a pivotably movable liquid crystal panel 59 and a separate wave plate filter 64 mountable to the liquid crystal panel 59. The separate wave plate filter 64 is provided at its lower portion with a pair of right and left adjusting cams 80R and 80L as position adjusting means for the separate wave plate filter 64 for use in mounting the filter 64 to the notebook computer 60.

The notebook computer 60 has a folding liquid crystal panel display portion 84 including the liquid crystal panel 59. The liquid crystal panel 59 is capable of displaying an image with a parallax. The liquid crystal panel 59 itself may be provided by a liquid crystal panel used in an image display portion of a normal notebook computer. In the case that an application for displaying a 3D image is not operated, the liquid crystal panel 59 can display a normal image (e.g., moving image and still image).

The notebook computer 60 further includes a keyboard 88 having character keys for inputting alphanumeric, hiragana, and katakana characters and various control keys on the front side of the liquid crystal panel 59. A palm rest 87 is provided on the immediately front side of the keyboard 88 toward the observer, and a pointer pad 86 is provided at a central portion of the palm rest 87.

The keyboard 88 is connected through a hinge portion 66 to the liquid crystal panel 59, so that the liquid crystal panel 59 is pivotably rotatable about the hinge portion 66. Accordingly, the liquid crystal panel 59 can be tilted at a desired angle about the hinge portion 66 by the observer, thereby obtaining a suitable viewing condition of the liquid crystal panel 59.

Further, a position adjusting pattern display program is preliminarily installed in a hard disk (not. shown) mounted in the notebook computer 60, and this program is read and executed by a central processing unit in the notebook computer 60 to thereby display the position adjusting pattern on the liquid crystal panel 59.

The image display portion 84 has a frame 35 formed of synthetic resin so as to surround the liquid crystal panel 59. Thus, the liquid crystal panel 59 is supported by the frame 85 of the image display portion 84.

A transversely extending projection 82 is formed below the image display portion 84 by projecting a part of the frame 85. The projection 82 projects to such an extent that the bottom end of the separate wave plate filter 64 comes into contact with the projection 82 and is sufficiently held by the projection 82 and that when the image display portion 84 is pivotally rotated toward the keyboard 88 to reach a folded condition, the projection 82 does not interfere with the keyboard 88.

As mentioned above, the separate wave plate filter 64 functions as a polarization control member obtained by arraying the bar-shaped separate wave plates 76 at intervals of one horizontal line of the pixel portions 78R, 78G, and 78B. The separate wave plate filter 64 is provided at its bottom portion with a horizontal holding member 81 formed of a material having a given rigidity, such as metal or synthetic resin. The adjusting cams 80R and 80L constituting a part of the position adjusting means are provided near the transversely opposite ends of the horizontal holding member 81.

The separate wave plate filter 64 is further provided at its upper end portion with a pair of right and left mounting screws 79R and 79L. After placing the filter 64 on the liquid crystal panel 59 and adjusting the position of the filter 64, the mounting screws 79R and 79L are engaged into a pair of tapped holes 83R and 83L formed in the upper end portion of the frame 85.

By the provision of the adjusting cams 80R and 80L as the position adjusting means in the horizontal holding member 81, the position of the separate wave plate filter 64 can be controlled by fine adjustment in the horizontal direction as the longitudinal direction of each bar-shaped separate wave plate 76 and/or in the vertical direction, thereby realizing an optimum 3D image. This will be hereinafter described in detail.

The basic structure of the 3D image display device 65 shown in FIG. 19 will now be described with reference to FIG. 20.

This 3D image display device 65 basically includes a liquid crystal panel 59 and a separate wave plate filter 64 to allow 3D vision. As similar to the structure shown in FIG. 18, the liquid crystal panel 59 includes a polarization plate 106 having a polarization angle indicated by the lines inclined upward to the left, a polarization plate 96 having a polarization angle indicated by the lines inclined upward to the right, a pair of transparent support substrates 74a and 74b interposed between the polarization plates 106 and 96, and an image display portion 75 interposed between the transparent support substrates 74a and 74b. The image display portion 75 includes a plurality of sets of red pixel portion 78R, green pixel portion 78G, and blue pixel portion 78B. Each set of pixel portions 78R, 78G, and 78B constitutes a three-color pixel trio, and the plural pixel trios are arranged in the form of a matrix.

Each of the pixel portions 78R, 78G, and 78B is provided with required electrical wiring to form a simple matrix structure or an active matrix structure, and in the case of displaying a 3D image the image display portion 75 displays image information according to a parallax.

Linearly polarized light passed through the polarization plate 96 on the transparent support substrate 74b side as opposed to the observer reaches the separate wave plate filter 64.

The separate wave plate filter 64 includes a transparent support substrate 74c formed of glass or the like and a plurality of bar-shaped separate wave plates (half-wave plates) 76 formed on one surface of the transparent support substrate 74c opposed to the liquid crystal panel 59. The separate wave plates 76 extend in the horizontal direction, and the width of each wave plate 76 is substantially equal to the width of each pixel line in the image display portion 75. Further, the gap between the adjacent wave plates 76 is also substantially equal to the width of each pixel line. The number of the separate wave plates 76 is ½ of the number of the pixel lines arranged in the vertical direction of the image display portion 75.

That is, the separate wave plates 76 are arrayed at intervals of one horizontal pixel line in the image display portion 75. Accordingly, an image for the right eye 72R or an image for the left eye 72L is passed through the separate wave plates 76 to thereby undergo 90° rotation of the polarization direction. On the other hand, the other image not passed through the separate wave plates 76 does not undergo rotation of the polarization direction.

The horizontal holding member 81 is mounted to the bottom end of the transparent support substrate 74c as a frame. The horizontal holding member 81 is formed at its transversely end portions with a pair of right and left tapped holes 90R and 90L for engagement with the adjusting cams 80R and 80L as the position adjusting means.

For realization of 3D vision, the polarization direction of polarized light from the image display portion 75 must be controlled to become different between the adjacent pixel lines by the separate wave plate filter 64, and at the time the polarized light is passed through the separate wave plates 76, two kinds of linearly polarized lights having perpendicular polarization directions must be separately obtained. The two kinds of linearly polarized lights from the separate wave plate filter 64 as the image for the right eye 72R and the image for the left eye 72L are passed through the right portion 57R and the left portion 57L of the polarization plate 69 (e.g., polarization spectacles) to enter the right eye 72R and the left eye 72L of the observer. Thus, the observer observes the right-eye image and the left-eye image with the right and left eyes 72R and 72L to recognize a 3D image.

However, if the polarization angle of the right portion 57R of the polarization plate 69 and the polarization angle of the left portion 57L of the polarization plate 69 become different from the polarization angles of the corresponding incident linearly polarized lights (e.g., when the observer's head wearing the polarization plate 69 is inclined), the 3D image is difficult to view.

To cope with this problem, a quarter-wave plate 89 is provided on the front side (observer side) of the separate wave plate filter 64 to thereby convert the two kinds of linearly polarized lights having perpendicular polarization directions emerging from the separate wave plate filter 64 respectively into circularly polarized lights. Furthermore, a quarter-wave plate 109 is provided on the back surface of the polarization plate 69 (each of the right and left portions 57R and 57L) so as to be opposed to the quarter-wave plate 89, thereby reconverting the circularly polarized lights into linearly polarized lights, which are next passed through the right and left portions 57R and 57L of the polarization plate 69.

By providing the pair of quarter-wave plates 89 and 109, the deviation in the polarization directions of linearly polarized lights incident on the quarter-wave plate 89 can be corrected by the circularly polarized lights reliably containing desired linearly polarized light components, and the desired linearly polarized light components are respectively input through the quarter-wave plate 109 into the right and left portions 57R and 57L. Accordingly, the 3D image can be reliably observed by the observer.

However, there is a possibility that the positional relation between the image display portion 75 and the separate wave plate filter 64 in the 3D image display device 65 may not be properly adjusted for the above-mentioned reasons as shown in FIG. 21A.

Referring to FIG. 21A, the separate wave plate filter 64 is slightly displaced relative to the image display portion 64 so that the direction of extension of the separate wave plates 76 is inclined with respect to the direction of extension of the horizontal pixel lines of the pixel portions 78R, 78G, and 78B to such an extent that the vertical displacement d1 is several % to tens of % of the size of the pixel portions 78R, 78G, and 78B. For example, when the size of the pixel portions 78R, 78G, and 78B is 250 μm, the vertical displacement d1 is about 50 μm (=250 μm×⅕).

As a result, a part of the polarized light from the pixel portions 78R, 78G, and 78B corresponding to the separate wave plates 76 is not passed through the separate wave plates 76, causing the occurrence of crosstalk between the pixel portions 78R, 78G, and 78B. The occurrence of crosstalk must be suppressed to display an optimum 3D image, and it is therefore necessary to perform the adjustment of position of the separate wave plate filter 64.

As shown in FIG. 21B, the separate wave plate filter 64 is adjusted in position to the image display portion 75 so that the separate wave plates 76 are precisely aligned to the corresponding horizontal lines of the pixel portions 78R, 78G, and 78B. This adjustment may be made by monitoring the adjusting display pattern displayed on the image display portion 75 through the polarization plate 69.

According to the positional relation shown in FIG. 21B, the light from the pixel portions 78R, 78G, and 78B corresponding to the separate wave plates 76 is entirely passed through the separate wave plates 76, and the light from the remaining pixel portions 78R, 78G, and 78B corresponding to the gaps between the separate wave plates 76 is not passed through the separate wave plates 76, thereby preventing the occurrence of crosstalk to allow the display of high-definition 3D image.

FIG. 22 shows the adjusting cams 80R and 80L as the position adjusting means for positioning the separate wave plate filter 64 and also shows a peripheral mechanism related to the adjusting cams 80R and 80L.

The horizontal holding member 81 extending along the entire transverse length of the lower end of the transparent support substrate 74c of the separate wave plate filter 64 is formed of a material having a relatively high rigidity, such as metal or resin, and is mounted through a semifixing resin material 101 to the lower end of the transparent support substrate 74c. By adjustably fixing the horizontal holding member 81 through the semifixing resin material 101 to the transparent support substrate 74c, it is possible to prevent the horizontal holding member 81 from being completely separated from the transparent support substrate 74c and to maintain the connection between the transparent support substrate 74c and the horizontal holding member 81 in finely adjusting the position of the transparent support substrate 74c by the operation of the adjusting cams 80R and 80L.

Although not shown, a pair of right and left springs as elastic members are provided at the upper end of the transparent support substrate 74c. The upper end of each spring abuts against the frame of the filter 64, and the lower end of each spring abuts against the upper surface of the transparent support substrate 74c.

The provision of the springs allows the fine adjustment by the adjusting cams 80R and 80L and easy positioning of the filter 64 in the vertical direction. Further, the springs do not interfere with changing of the filter position after adjustment or can prevent displacement of the filter due to play.

Each of the adjusting cams 80R and 80L as the position adjusting means includes an eccentric rod 103. A position adjusting method using the adjusting cams 80R and 80L will now be described in more detail.

The adjusting cams 80R and 80L are located at the lower end portion of the transparent support substrate 74c, and are threadedly engaged with the tapped holes 90R and 90L formed through the horizontal holding member 81. The eccentric rod 103 of each of the adjusting cams 80R and 80L extends from the threaded portion of each cam so as to be eccentric from the center of rotation of each cam.

The lower end of the transparent support substrate 74c is formed with a pair of recesses 100 for receiving the eccentric rods 103 of the cams 80R and 80L. Each eccentric rod 103 has a front end portion 77 abutting against the bottom of the corresponding recess 100 of the transparent support substrate 74c. When the cams 80R and 80L are rotationally operated, the eccentric rods 103 in the recesses 100 operate to raise the transparent support substrate 74c against the weight thereof or to lower the substrate 74c due to its own weight.

For example, when the cams 80R and 80L are rotated clockwise, the substrate 74c is raised by the eccentric rods 103, whereas when the cams 80R and 80L are rotated counterclockwise, the substrate 74c is lowered by its own weight as being supported by the eccentric rods 103.

The bottom surface of each recess 100 is smoothly curved to thereby allow smooth rotation of the cams 80R and 80L. Each of the cams 80R and 80L is provided with a disk-shaped knob 102 having a knurled outer circumferential surface for easy rotation of each cam.

By using the position adjusting means including the cams 80R and 80L, the position of the substrate 74c can be reliably adjusted, and the adjusted position can be checked in real time. Further, since a 3D image can be displayed without the occurrence of crosstalk by the adjustment of position of the substrate 74c, the high-definition separate wave plate filter 64 can be used always in its optimum condition, thereby allowing the observation of a high-definition, realistic 3D image always in an optimum condition.

Further, the resolution of images in multiscreen image display can also be improved and image display can be performed without the occurrence of crosstalk between the pixel portions 78R, 78G, and 78B. Further, the position setting work for the separate wave plate filter 64 is manually performed by the observer, so that the observer can understood the principle of 3D image display and can utilize this work for the education of video engineering. In addition, time and effort for prefixing the position of the separate wave plate filter 64 can be omitted at the factory.

However, it has been found that although the position of the separate wave plate filter 64 is adjusted to a proper position, the following problem still remains.

In the case that a 3D image is observed through the polarization plate 69 by the right eye 72R and the left eye 72L of the observer as in FIG. 18, the angle or position of observation by the observer to the image display portion 75 frequently differs according to circumstances.

That is, even when the position of the separate wave plate filter 64 is fixed to an optimum position by the above-mentioned position adjusting mechanism, the angle or position of the polarization plate 69 (e.g., polarization spectacles) changes according to a seating position or the other conditions on the observer. As a result, the distance (space), parallelism, and alignment between the separate wave plate filter 64 and the polarization plate 69 are changed.

When the optimum distance between the separate wave plate filter 64 and the polarization plate 69 is difficult to hold and the polarization plate 69 comes into misalignment with the separate wave plate filter 64, there arises a problem that the light quantity of polarized light entering each of the right and left portions 57R and 57L of the polarization plate 69 is reduced or the lights entering the right and left eyes are not focused to cause difficulty of image formation. In some case, the incident lights may interfere with each other to cause the occurrence of crosstalk or the like, so that a 3D image is difficult to clearly observe.

To prevent this problem, the observer must adjust the polarization plate 69 to an optimum distance and position with respect to the separate wave plate filter 64 as required, so that the adjustment of the polarization plate 69 is troublesome and prone to be poorly made.

### SUMMARY OF THE INVENTION

It is accordingly an object of the present invention to provide a 3D image display device which can obtain a clear 3D image relatively easily, accurately, and quickly.

It is another object of the present invention to provide a position holding mechanism for polarization means for use with the 3D image display device.

It is a further object of the present invention to provide such polarization means for use with the 3D image display device.

In accordance with the present invention, there is provided a 3D image display device having an image display portion for displaying image information according to a parallax separately in a first segment and a second segment, polarization direction converting means opposed to the first and second segments of the image display portion for converting a polarization direction of polarized light of the image information from the first segment into a direction different from a polarization direction of polarized light of the image information from the second segment, and polarization means having a first polarization plate portion and a second polarization plate portion to which the polarized lights separated by the polarization direction converting means are respectively input, the 3D image display device including a position holding mechanism for holding the positional relation between the polarization means and the polarization direction converting means. There is also provided such a position holding mechanism for use with the above 3D image display device, and there is also provided such polarization means for use with the above 3D image display device.

According to the present invention, the position holding mechanism is so configured as to hold the positional relation of the polarization means (e.g., a polarization plate located in the vicinity of the observer's eyes) to the polarization direction converting means (e.g., a separate wave plate filter), and this position holding mechanism is additionally provided in the 3D image display device. Accordingly, the distance (space), parallelism, and alignment between the polarization direction converting means and the polarization means can be kept always constant. Even when the angle of the polarization means is changed, the distance, parallelism, and alignment between the polarization means and the polarization direction converting means remains unchanged, so that the polarized lights from the first and second segments of the image display portion can be respectively input into the first and second polarization plate portions in a reliably separated condition with a sufficient light quantity and an accurate focus. As a result, a clear 3D image can be always obtained.

Further, the observer need not perform the adjustment of position of the polarization means owing to the provision of the position holding mechanism for holding the positional relation between the polarization means and the polarization direction converting means, so that the observer can observe a 3D image relatively easily and quickly.

According to the present invention as described above, the position holding mechanism is so configured as to hold the positional relation of the polarization means to the polarization direction converting means, and this position holding mechanism is additionally provided in the 3D image display device. Accordingly, the distance (space), parallelism, and alignment between the polarization direction converting means and the polarization means can be kept always constant. Even when the angle of the polarization means is changed, the distance, parallelism, and alignment between the polarization means and the polarization direction converting means remains unchanged, so that the polarized lights from the first and second segments of the image display portion can be respectively input into the first and second polarization plate portions in a reliably separated condition with a sufficient light quantity and an accurate focus. As a result, a clear 3D image can be always obtained.

Further, the observer need not perform the adjustment of position of the polarization means owing to the provision of the position holding mechanism for holding the positional relation between the polarization means and the polarization direction converting means, so that the observer can observe a 3D image relatively easily and quickly.

### BRIEF DESCRIPTION OF THE DRAWINGS

FIG. 1A is a perspective view of a polarization plate holder according to a first preferred embodiment of the present invention in the condition where a polarization plate is mounted to the polarization plate holder;

FIG. 1B is a view similar to FIG. 1A, showing a condition that the polarization plate holder is mounted to an image display portion;

FIG. 2A is a side view of the image display portion in its upright condition;

FIG. 2B is a view similar to FIG. 2A, showing a tilted condition of the image display portion;

FIG. 3 is a perspective view showing a modification of the polarization plate holder;

FIGS. 4A and 4B are schematic perspective views showing the configuration of a 3D image display device according to a second preferred embodiment of the present invention;

FIGS. 5A and 5B are perspective views of a polarization plate holder to which a polarization plate is mounted, showing the conditions respectively corresponding to those shown in FIGS. 4A and 4B;

FIGS. 6A and 6B are perspective views showing modifications of the polarization plate holder according to the second preferred embodiment;

FIGS. 7A, 7B, 7C, and 7D are elevational views showing a process of adjustment of another polarization plate;

FIGS. 8A and 8B are elevational views showing a process of adjustment of another polarization plate;

FIGS. 9A and 9B are elevational views showing a process of adjustment of another polarization plate;

FIGS. 10A, 10B, and 10C are elevational views showing a process of adjustment of another polarization plate;

FIGS. 11A, 11B, and 11C are elevational views showing a process of adjustment of another polarization plate;

FIGS. 12A, 12B, and 12C are elevational views showing a process of adjustment of another polarization plate;

FIGS. 13A and 13B are elevational views showing a process of adjustment of another polarization plate;

FIGS. 14A and 14B are elevational views showing a process of adjustment of another polarization plate;

FIGS. 15A, 15B, and 15C are elevational views showing a process of adjustment of another polarization plate;

FIGS. 16A and 16B are perspective views showing the configuration of polarization spectacles as an example of the polarization plate according to the second preferred embodiment;

FIG. 17A is an enlarged sectional view of a part of the polarization plate according to the second preferred embodiment;

FIG. 17B is a view similar to FIG. 17A, showing a modification;

FIG. 18 is an exploded perspective view schematically showing the configuration of a 3D image display device in the prior art;

FIG. 19 is a perspective view of a related 3D image display device in the condition before mounting a separate wave plate filter to a notebook computer;

FIG. 20 is an exploded perspective view schematically showing the configuration of the 3D image display device shown in FIG. 19;

FIGS. 21A and 21B are perspective views for illustrating the positional relation between an image display portion and the separate wave plate filter shown in FIG. 20; and

FIG. 22 is an enlarged sectional view of an essential part of a position adjusting mechanism for the separate wave plate filter shown in FIG. 19.

### DETAILED DESCRIPTION OF THE PREFERRED EMBODIMENTS

The polarization direction converting means can includes a separate wave plate filter (e.g., a filter having a plurality of separate half-wave plates), wherein the polarized lights separated by the separate wave plate filter are respectively input into the first polarization plate portion and the second polarization plate portion.

More preferably, the separate wave plate filter includes a half-wave plate, and a quarter-wave plate is interposed between the image display portion and the polarization means.

Alternatively, the separate wave plate filter may include a half-wave plate, and a half-wave plate may be provided on one of the first and second polarization plate portions of the polarization means so as to face the image display portion.

In this case, the first and second polarization plate portions are preferably changeable in position, so that the image information displayed on the image display portion can be changed from a 3D image to a 2D image or vice versa.

In order to maintain the above-mentioned positional relation even when the angle of the polarization means is changed with a change in position of the image display portion, the position holding mechanism preferably includes an arm having a first end for supporting the polarization means and a second end fixed to a frame of the image display portion.

More preferably, the position holding mechanism further includes click type position adjusting means provided at the first end of the arm for adjusting the position of the polarization means, whereby the polarization means can be adjusted in position or moved to an inoperative position.

More preferably, the position holding mechanism further includes click type position adjusting means provided at the second end of the arm for adjusting the position of the arm, and the second end of the arm is fixed through this click type position adjusting means to the frame of the image display portion (especially at the upper end of the frame), whereby the arm can be changed in position relatively easily.

In order to widen the range of position adjustment of the polarization means or the arm by the position adjusting means, the position adjusting means preferably has a mechanical angle adjusting mechanism for changing the position of the polarization means or the arm in at least one of a longitudinal direction, a lateral direction, and a vertical direction.

In particular, the polarization means is preferably rotatable relative to the polarization direction converting means in at least one of the longitudinal, lateral, and vertical directions, whereby the position adjustment of the polarization means relative to the polarization direction converting means can be performed relatively easily.

Further, the arm is preferably extendable and contractable in its longitudinal direction, whereby the position adjustment of the polarization means relative to the polarization direction converting means can be performed relatively easily, or the polarization means can be moved to its inoperative position.

In the case that the image display portion is adjustable in angular position as in a notebook computer, the polarization means can be always adjusted to a proper position easily and quickly by the position holding mechanism even when the angle of the image display portion is changed.

Preferably, the surface of the polarization means is covered with a transparent protective material, whereby the polarization means can be protected and the flatness of the surface of the polarization means can be improved.

There will now be described some preferred embodiments of the present invention with reference to the drawings.

### First Preferred Embodiment

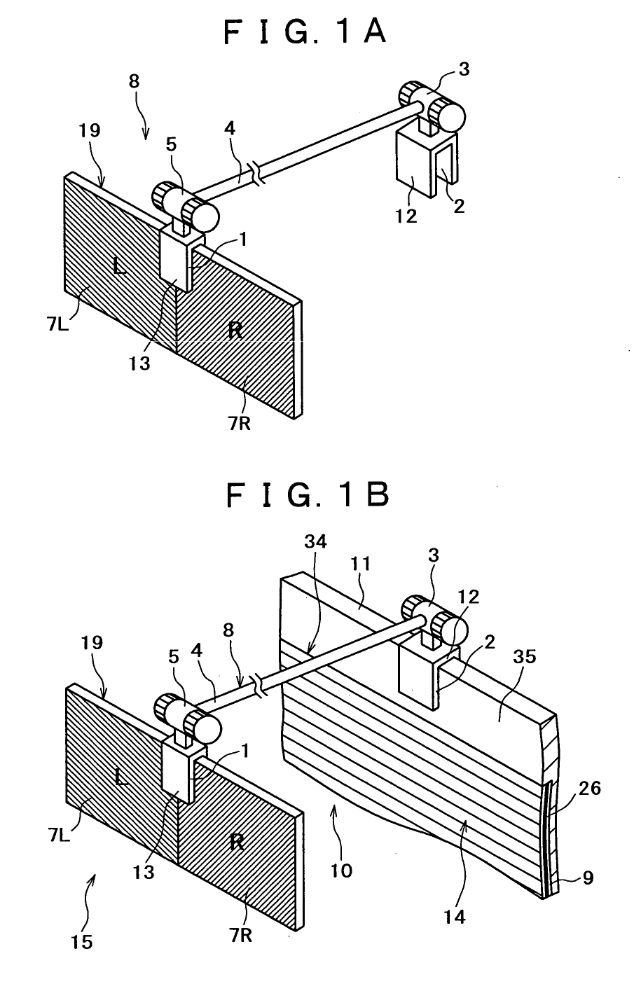

Referring to FIGS. 1A and 1B, there is shown a polarization plate holder 8 as the position holding mechanism according to a first preferred embodiment of the present invention.

The polarization plate holder 8 has an invertedly U-shaped bracket 12. The bracket 12 has a mounting portion 2 adapted to be fixed to an upper end portion 11 of an image display portion 34. The bracket 12 is provided with a click type position adjusting portion 3. The position adjusting portion 3 has an integral arm 4 extending frontward therefrom. The arm 4 is connected at its front end through a click type position adjusting portion 5 to an invertedly U-shaped bracket 13. The bracket 13 has a mounting portion 1 for mounting a polarization plate 19 to be located in the vicinity of the eyes of an observer.

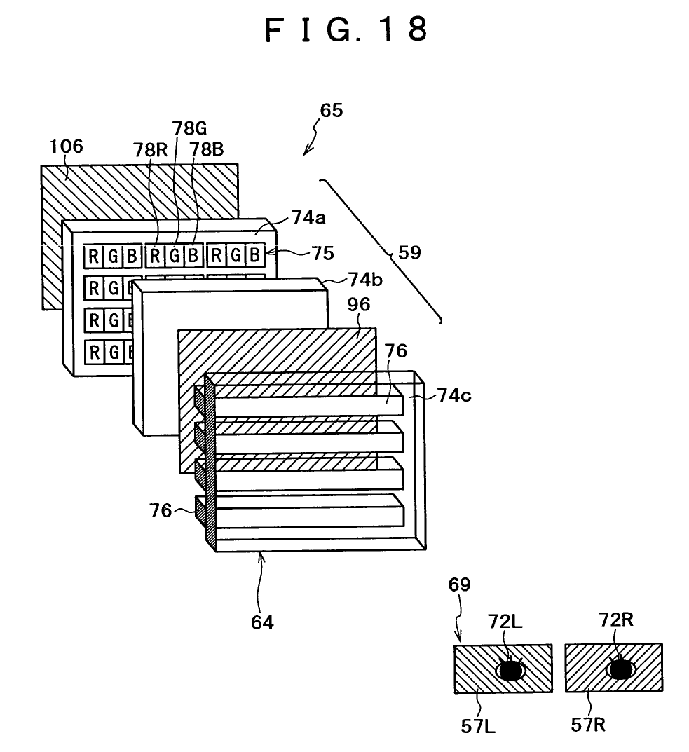

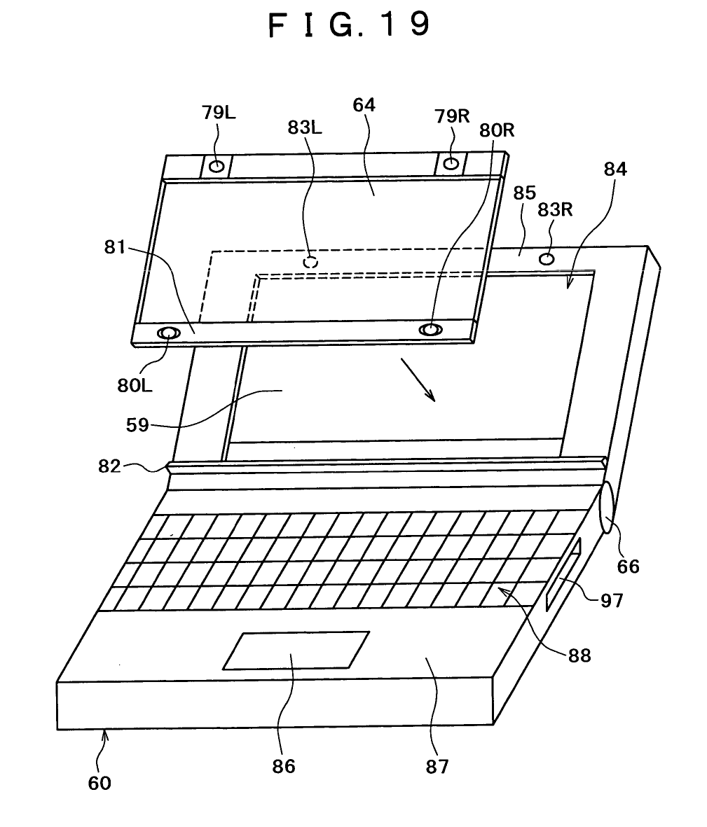

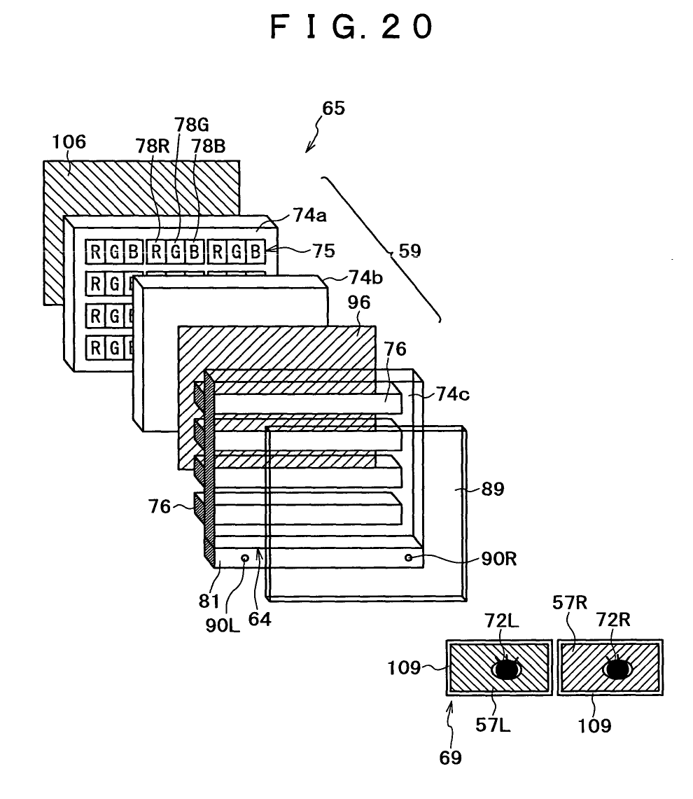

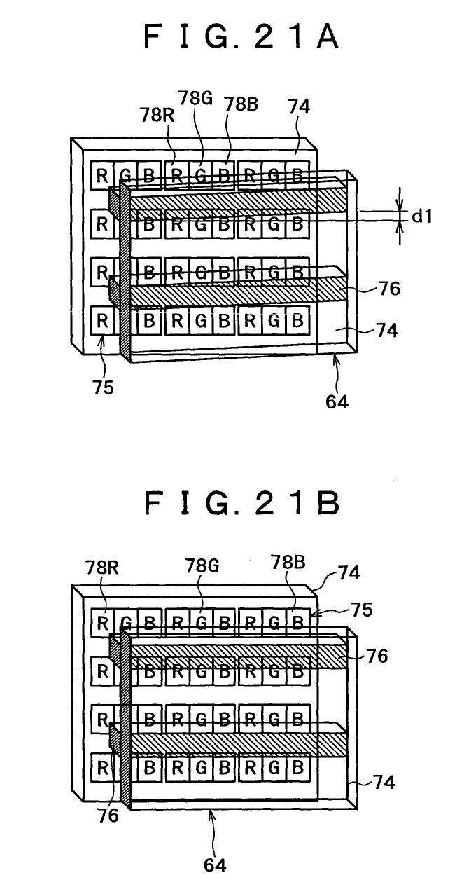

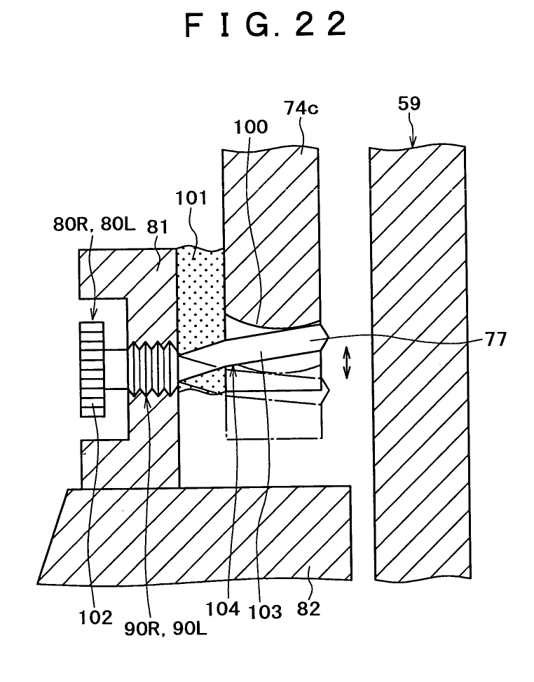

The polarization plate 19 is detachably fixed at its upper central position to the bracket 13. As in FIG. 18 or 20, the polarization plate 19 is used in observing a 3D image, and it is composed of a right portion 7R for the right eye of the observer and a left portion 7L for the left eye of the observer. The right portion 7R of the polarization plate 19 has a polarization angle indicated by the lines inclined upward to the right, and the left portion 7L of the polarization plate 19 has a polarization angle indicated by the lines inclined upward to the left.

FIG. 1B shows a part of a notebook computer 10. As in FIG. 18 or 20, the notebook computer 10 has a liquid crystal display portion 34 composed of a liquid crystal panel 9, a separate wave plate filter 14, and a frame 35 for supporting these members 9 and 14. As mentioned above, the bracket 12 of the polarization plate holder 8 is engaged with the upper end portion 11 of the frame 35 at its central position, thereby fixing the polarization plate holder 8 at its one end to the frame 35.

The separate wave plate filter 14 may be similar to the separate wave plate filter 64 shown in FIG. 18 or 20. As shown in FIG. 1B, the separate wave plate filter 14 includes a plurality of separate wave plates (quarter-wave plates) 26. Although not shown in FIGS. 1A and 1B, it is preferable to provide the quarter-wave plate 89 on the front surface of the separate wave plate filter 14 and the quarter-wave plate 109 on the back surface of the polarization plate 19 as in FIG. 20 for the above-mentioned reason.

In this preferred embodiment, a 3D image display device 15 is configured by the combination of the polarization plate 19 and the image display portion 34 having the separate wave plate filter 14. However, the image display device 15 may be configured by fixing the polarization plate holder 8 having the polarization plate 19 to the frame 35. Further, the image display device 15 may be configured solely by the image display portion 34 to which the polarization plate holder 8 and the polarization plate 19 are to be fixed as options. In any case, each configuration is included in the scope of the present invention.

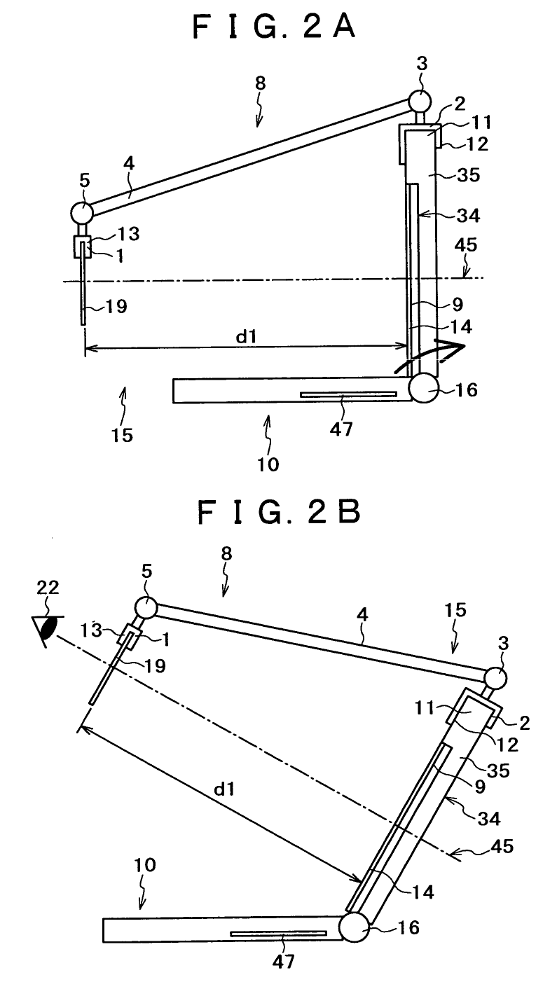

FIG. 2A shows a condition where the image display portion 34 of the notebook computer 10 has been pivotally rotated about a hinge portion 16 to keep an upright position.

In this upright position of the image display portion 34, the position adjusting portions 3 and 5 of the polarization plate holder 8 fixed to the frame 35 are rotationally operated in a clicking fashion clockwise or counterclockwise as viewed in FIG. 2A, thereby adjusting the angle between the arm 4 and the polarization plate 19 mounted to the bracket 13, maintaining the distance or space between the polarization plate 19 and the image display portion 34 (i.e., the separate wave plate filter 14) at a preset value d1, maintaining the parallelism between the polarization plate 19 and the separate wave plate filter 14, and aligning the polarization plate 19 and the separate wave plate filter 14.

Thus, the distance and parallelism between the polarization plate 19 and the separate wave plate filter 14 can be maintained and a common center line 45 can be established by the alignment of the polarization plane 19 and the separate wave plate filter 14 easily, reliably, and quickly by the click operation of the position adjusting portions 3 and 5. Accordingly, when the observer observes the image display portion 34 through the polarization plate 19, a clear 3D image can be easily observed on the basis of the above-mentioned principle. In the position adjustment mentioned above, the polarization plate 19 or the arm 4 may be rotated not only vertically (about a horizontal axis), but also horizontally (about a vertical axis) . Further, the arm 4 may be extendably configured like a telescopic sleeve so that the length of the arm 4 is adjustable.

Even when the seating position of the observer is changed, for example, to result in a change in vertical position of the eyes 22 of the observer after setting the positional relation between the polarization plate 19 and the separate wave plate filter 14, and in response thereto the image display portion 34 is pivotally rotated about the hinge portion 16 from the upright condition shown in FIG. 2A as indicated by the arrow to a tilted position shown in FIG. 2B, the positional relation between the polarization plate 19 and the separate wave plate filter 14 shown in FIG. 2A can be maintained, so that the optimum position of the polarization plate 19 for the observation by the observer can be fixed irrespective of a change in tilt angle of the image display portion 34.

Accordingly, the observer can always observe a clear 3D image easily and reliably at any angle of viewing to the image display portion 34. Further, by initially setting the optimum position of the polarization plate 19, the need for subsequent correction of the angle of the polarization plate 19 can be eliminated or the angle of the polarization plate 19 can be easily adjusted by the click operation of the position adjusting portion 5 even after changing the angle of the image display portion 34. As a result, it is possible to reduce the time and effort for adjustment of the position of the polarization plate 19 in response to every change in angle of the image display portion 34.

In the condition shown in FIG. 2A or 2B, the separate wave plate filter 14 can be positioned relative to the image display portion 34 so that the separate wave plates 26 are aligned to the corresponding pixel lines as viewing a display pattern on the image display portion 34. At this time, the positional relation between the polarization plate 19 and the separate wave plate filter 14 as set in FIG. 2A must be maintained.

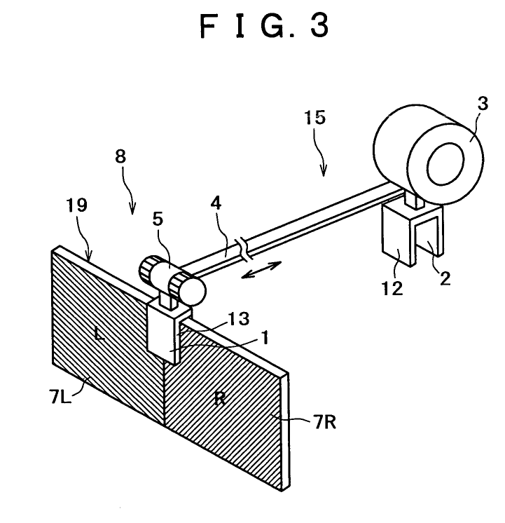

As shown in FIG. 3, the position adjusting portion 3 may be further provided with a tape measure type mechanism for variably adjusting the length of the arm 4 in addition to the above-mentioned angle adjusting mechanism. In this case, the distance between the polarization plate 19 and the separate wave plate filter 14 can be arbitrarily changed, and the arm 4 can be contracted as greatly as possible when not used.

Even when the size or focal length of the image display portion 34 is changed, the polarization plate 19 fixed to the bracket 13 can be relatively easily located at an optimum distance from the image display portion 34 by extending or contracting the arm 4. Thus, the polarization plate holder 8 shown in FIG. 3 can be applied to various kinds of image display portions, and the observer can always easily observe a clear 3D image.

The liquid crystal panel 9 has the same structure as that of the liquid crystal panel 59 shown in FIG. 20, and the light for the left eye 72L and the light for the right eye 72R for 3D image display are output from the liquid crystal panel 9 composed of the polarization plate 106, the transparent support substrate 74a, the image display portion 34 having the plural sets of pixel portions 78R, 78G, and 78B, the transparent support substrate 74b, and the polarization plate 96. The lights output from the liquid crystal panel 9 are passed through the separate wave plate filter 14 composed of the separate wave plates 26 and the transparent support substrate to selectively convert the polarization direction. The polarized lights passed through the separate wave plate filter 14 are next passed through the quarter-wave plates 89 and 109 to enter the polarization plate 19 (e.g., polarization spectacles) composed of the left portion 7L and the right portion 7R. The lights passed through the polarization plate 19 as the image information for the left eye 72L and the right eye 72R are observed as a 3D image by the observer.

According to this preferred embodiment, the polarization plate holder 8 is additionally provided as a mechanism for maintaining the positional relation between the polarization plate 19 and the separate wave plate filter 14, so that the polarization plate 19 and the separate wave plate filter 14 can be aligned with each other and the optimum distance therebetween can be maintained. Accordingly, even when the tilt angle of the image display portion 34 is changed, the polarized lights having different polarization directions separated by the separate wave plate filter 14 can be respectively input into the right portion 7R and the left portion 7L in a clearly separated condition, thereby allowing the observation of a clear 3D image by the observer.

Further, since the polarization plate holder 8 for maintaining the positional relation between the polarization plate 19 and the separate wave plate filter 14 is additionally provided, the need for adjustment of position of the polarization plate 19 according to the observer can be eliminated to thereby allow relatively easy observation of a 3D image.

Second Preferred Embodiment

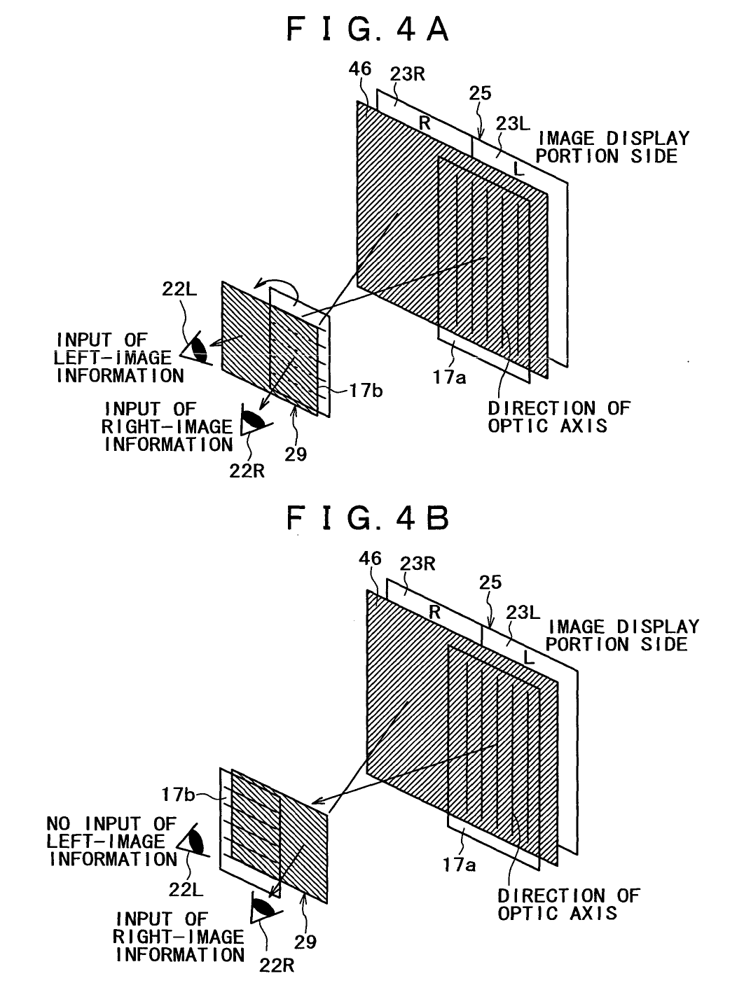

As shown in FIG. 4A, a half-wave plate 17a is located on the front side of a polarization plate 46 (corresponding to the polarization plate 96 shown in FIG. 18) in the vicinity thereof in a region corresponding to a left-eye image 23L on an image display portion 25. Further, a half-wave plate 17b is located on the back side of a polarization plate 29 provided in the vicinity of the observer in a region corresponding to the right eye 22R of the observer. The polarization plate 29 has a polarization angle indicated by the lines inclined upward to the left (commonly to the right and left eyes). The half-wave plate 17b located near the polarization plate 29 faces the half-wave plate 17a located near the polarization plate 46. The other configuration is similar to that of the first preferred embodiment.

The polarization plate 46 having a polarization angle indicated by the lines inclined upward to the right is provided on the front side of the image display portion 25 composed of a left-eye image 23L and a right-eye image 23R forming a 3D image. The half-wave plate 17a having an optic axis inclined 45° with respect to the polarization angle of the polarization plate 46 is provided on the front side of the polarization plate 46 in its right half region. Although the half-wave plate 17a is simply illustrated, it is actually composed of arrayed wave plates which may be arrayed like the separate wave plates 76 shown in FIG. 18.

The polarization plate 29 has a polarization angle indicated by the lines inclined upward to the left, and it is spaced a given distance from the image display portion 25. For example, the polarization plate 29 is provided by a pair of polarization spectacles to be worn by the observer. The half-wave plate 17b having an optic axis perpendicular to the optic axis (vertical optic axis) of the half-wave plate 17a is provided on the back side of the polarization plate 29 in its region corresponding to the right eye 22R. The image display portion 25 displays the left-eye image 23L in the right half region as viewed from the observer and the right-eye image 23R in the left half region as viewed from the observer.

In the condition shown in FIG. 4A, the input of the right-eye image 23R into the left half region of the polarization plate 29 to be observed by the left eye 22L of the observer is completely blocked because the polarization angles of the polarization plate 46 and the polarization plate 29 are perpendicular to each other. In contrast, the left-eye image 23L can be observed by the left eye 22L of the observer because the polarization angle of the polarization plate 46 is rotated 90° by the half-wave plate 17a interposed between the polarization plate 46 and the polarization plate 29, resulting in coincidence of the polarization angles of the polarization plate 46 and the polarization plate 29.

On the other hand, the right-eye image 23R can be observed by the right eye 22R of the observer because the polarization angle of the polarization plate 46 is rotated 90° by the half-wave plate 17b interposed between the polarization plate 46 and the polarization plate 29, resulting in coincidence of the polarization angles of the polarization plate 46 and the polarization plate 29.

In contrast, the left-eye image 23L to the right eye 22R of the observer is completely blocked because the optic axes of the half-wave plates 17a and 17b interposed between the polarization plate 46 and the polarization plate 29 are perpendicular to each other, so that the phase difference by the half-wave plate 17a is canceled by the phase difference by the half-wave plate 17b to result in such a condition obtained as if these half-wave plates 17a and 17b were absent.

Thus, the incident light from the left-eye image 23L on the right half portion of the polarization plate 29 facing the right eye 22R is completely blocked by the two half-wave plates 17a and 17b having orthogonal optic axes. Accordingly, the left-eye image 23L and the right-eye image 23R can be respectively observed by the left eye 22L and the right eye 22R as completely independent lights without crosstalk, thereby displaying a clear 3D image.

In positioning the half-wave plate 17a relative to the image display portion 25 before observing a 3D image, the polarization plate 29 whose right half region corresponding to the right eye 22R is provided with the half-wave plate 17b is rotated 180° horizontally (about a vertical axis) as shown by the arrow in FIG. 4A to thereby obtain a condition shown in FIG. 4B wherein the half-wave plate 17b is located on the left half region of the polarization plate 29 corresponding to the left eye 22L so as to face the observer.

In this condition shown in FIG. 4B, the right-eye image 23R can be observed by the left eye 22L because the polarization angle of the polarization plate 46 is similar to that of the polarization plate 29. The left-eye image 23L cannot substantially be observed by the left eye 22L because the polarization angle of the polarization plate 46 is rotated 90° by the half-wave plate 17a interposed between the polarization plate 46 and the polarization plate 29.

On the other hand, the right-eye image 23R can be observed by the right eye 22R because the polarization angle of the polarization plate 36 is similar to that of the polarization plate 29. The left-eye image 23L cannot substantially be observed by the right eye 22R because the polarization angle of the polarization plate 46 is rotated 90° by the half-wave plate 17a interposed between the polarization plate 46 and the polarization plate 29.

Accordingly, in the condition shown in FIG. 4B, the right-eye image 23R is input into the right and left eyes 22R and 22L, and the left-eye image 23L is not input into the right and left eyes 22R and 22L. As a result, the two-dimensional right-eye image 23R (i.e., 2D image) without displacement can be observed simultaneously by the right and left eyes 22R and 22L, so that the adjustment of position of the half-wave plate 17a can be made with the right and left eyes 22R and 22L open, thus allowing easy and accurate adjustment. That is, even when the observer is weak in the adjustment of position with either eye closed, the observer can easily make the adjustment of position with both eyes open by a relatively simple operation of 180° rotating the polarization plate 29.

If the adjustment of position of the half-wave plate 17a (or the separate wave plate filter 14) is made in the condition shown in FIG. 4A, the left-eye image 23L and the right-eye image 23R are input into both eyes of the observer, so that the position adjusting patterns on the image display surface are overlapped to cause difficulty of the adjustment. In this case, however, the overlap of the position adjusting patterns can be avoided by closing either eye to observe either the left-eye image 23L or the right-eye image 23R. However, this method is not suitable for the observer weak in closing either eye, and the adjustment itself by this method is not so easy.

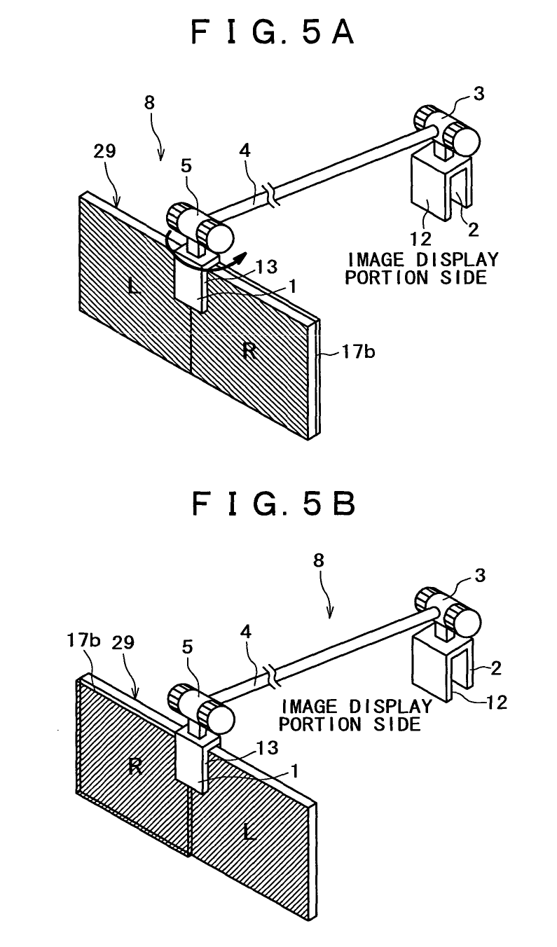

FIGS. 5A and 5B show an application of the structure according to this preferred embodiment to the polarization plate holder 8 shown in FIG. 1A, so as to effectively perform the method mentioned above with reference to FIGS. 4A and 4B (the image display portion and its related parts being not shown in FIGS. 5A and 5B).

As shown in FIG. 5A, the polarization plate 29 is fixed to the bracket 13 of the polarization plate holder 8, and the half-wave plate 17b is provided on the back side of the right half portion of the polarization plate 29 as viewed from the observer toward the image display surface. By 180° rotating the polarization plate 29 horizontally (about a vertical axis) as shown by the arrow in FIG. 4A, the half-wave plate 17b can be moved so as to face the left eye of the observer as shown in FIG. 5B. After completing the adjustment of position of the half-wave plate 17a in the condition shown in FIG. 4B or 5B, the polarization plate 29 is horizontally rotated 180° to the condition shown in FIG. 4A or 5A to thereby allow the observation of an intended 3D image (ditto for the following examples).

Thus, only by rotating the polarization plate 29, the display mode can be easily changed from a 3D image to a 2D image or vice versa (ditto for the following examples).

Usually, a separate wave plate filter is adjusted in position by displaying a pattern on a display surface and using a pair of spectacles for 3D vision to observe the pattern with either eye closed in such a manner that the pattern becomes red as a whole with the right eye, for example. However, because keeping either eye closed causes fatigue, a polarization plate is additionally provided perpendicularly or parallel to the polarization plate of an LCD to allow viewing of the same image with both eyes. In this condition, the position of the filter is adjusted so that the pattern becomes red as a whole with both eyes. However, this method requires the additional polarization plate for the adjustment of position of the filter, and the operation is not so easy. To the contrary, the method according to this preferred embodiment as shown in FIGS. 4A to 5B has such an advantage that the adjustment of position of the filter can be made with both eyes only by inverting the polarization plate 29, thereby simplifying the required means for the adjustment and facilitating the adjustment work.

Moreover, this preferred embodiment can exhibit additional effects similar to those of the first preferred embodiment mentioned above.

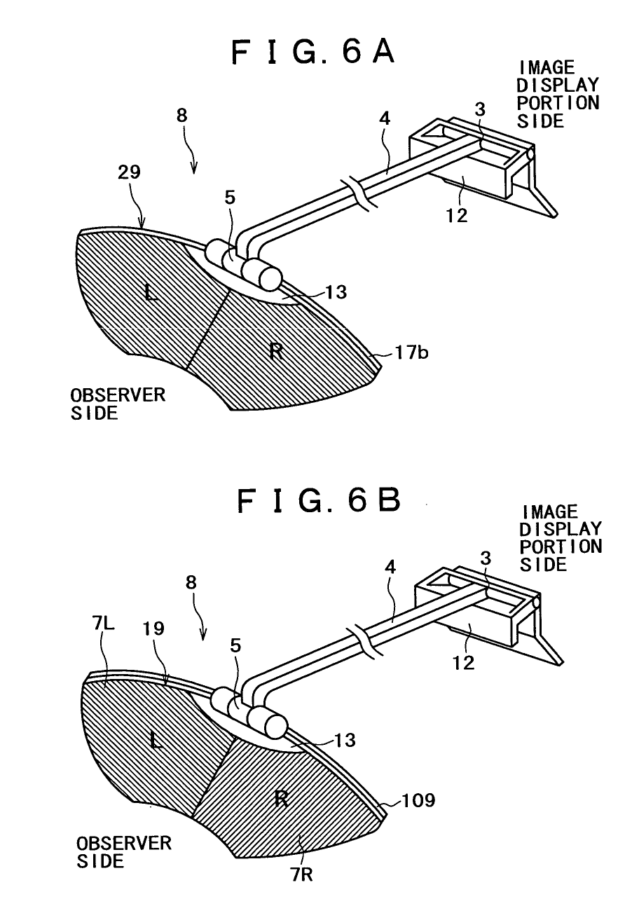

Other examples of the polarization plate holder 8 according to this preferred embodiment will now be described with reference to FIGS. 6A to 15C.

The polarization plate holder 8 shown in FIG. 6A is similar in configuration to that shown in FIGS. 5A and 5B. The difference is that the polarization plate 29 is substantially sectorial as viewed in elevation and the clip type bracket 13 is substantially arcuate as viewed in elevation. The polarization plate 29 is detachably fixed through the bracket 13 to one end of the arm 4, and the other end of the arm 4 is detachably fixed through the clip type bracket 12 to the frame of the image. display portion (not shown).

In this example, the position adjusting portion 5 and the position adjusting portion 3 employ the respective clip type mechanisms, so that the polarization plate 29 can be relatively easily mounted to the polarization plate holder 8 or the polarization plate holder 8 can be relatively easily mounted to the image display portion. Further, the polarization plate 29 is smart or sleek in shape.

Such a configuration may be applied also to the polarization plate holder 8 shown in FIG. 6B corresponding to the preferred embodiment shown in FIGS. 1A and 1B (such applicability applies also to the following examples).

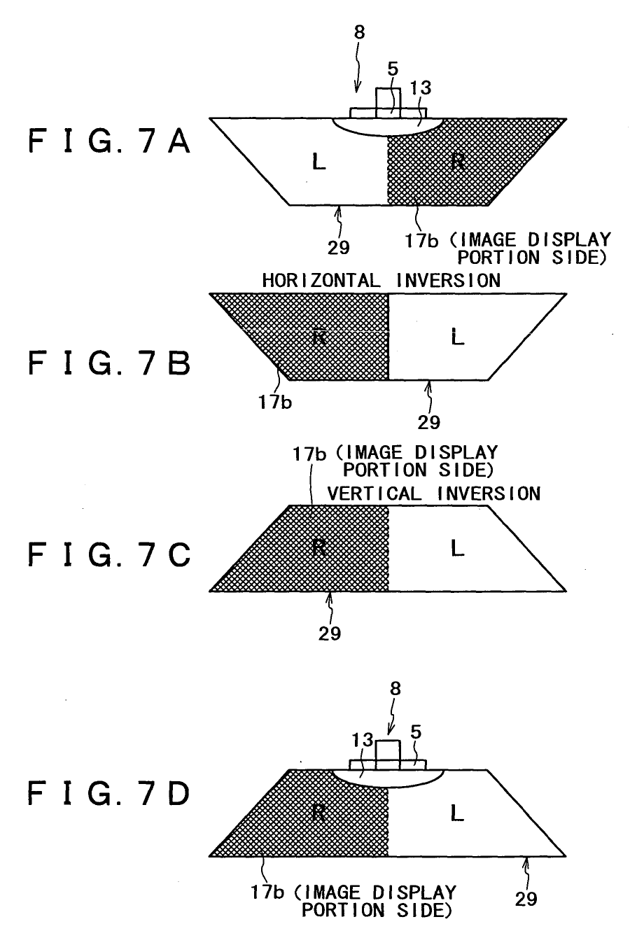

The polarization plate holder 8 shown in FIG. 7A is used to fix an inverted-trapezoidal polarization plate 29. Although not shown, this polarization plate 29 has a polarization direction similar to that of the polarization plate 29 shown in FIG. 6A (ditto for the following examples). A half-wave plate 17b is provided on the back side of the right half portion of the polarization plate 29 so as to face the image display portion. The polarization plate 29 is mounted at its central upper end portion to the clip type bracket 13 of the position adjusting portion 5.

By horizontally inverting the polarization plate 29 (180° rotating about a vertical axis) through a rotating mechanism (not shown) of the position adjusting portion 5, the polarization plate 29 is brought into a condition shown in FIG. 7B substantially similar to the condition shown in FIG. 5B. Accordingly, although not shown in FIG. 7B, the half-wave plate 17a (or the separate wave plate filter 14) provided on the image display portion can be easily adjusted in position for the reason mentioned above.

Further, by removing the polarization plate 29 shown in FIG. 7B from the clip mechanism (the clip type bracket 13) of the position adjusting portion 5, next vertically inverting the polarization plate 29 (180° rotating about a horizontal axis) as shown in FIG. 7C, and next mounting the polarization plate 29 shown in FIG. 7C to the clip mechanism of the position adjusting portion 5, it is possible to obtain a condition such that the right and left half portions of the polarization plate 29 shown in FIG. 7A are respectively reversed to the left and right half portions, so that the half-wave plate 17b is provided on the back side of the left half portion of the polarization plate 29.

This configuration is effective in the case that the right-eye image and the left-eye image are reversed to each other or the positional relation between the filter and the image display portion is prefixed and improperly reversed in horizontal position. Accordingly, by reversing the right and left half portions of the polarization plate 29 to the left and right half portions, respectively, the image can be properly observed.

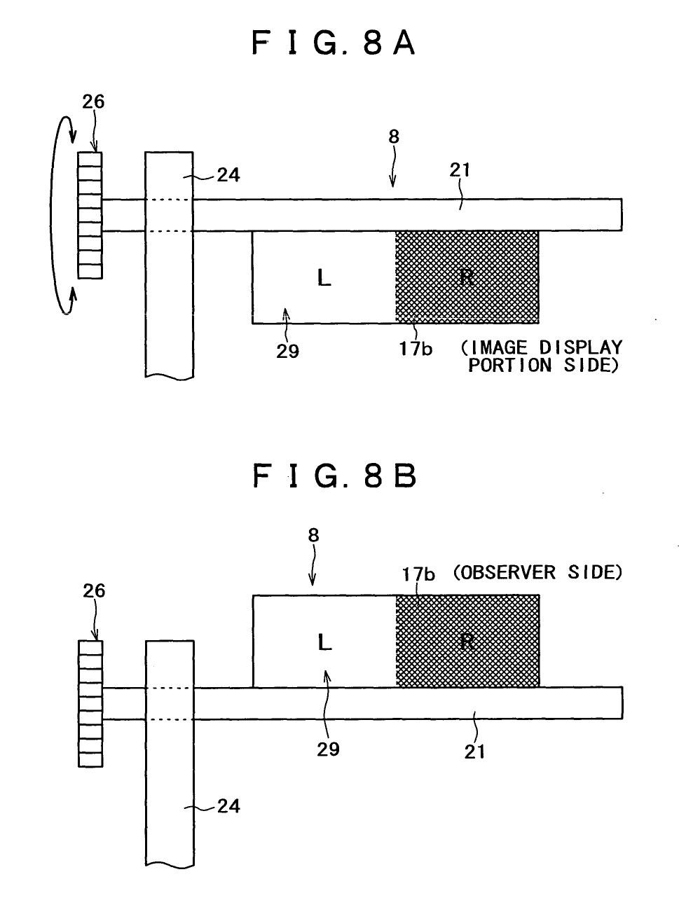

The polarization plate holder 8 shown in FIG. 8A has a vertically extending support rod 24, a horizontally extending shaft 21 inserted through the support rod 24 at right angles thereto, a position adjusting portion 26 rotatably provided at one end of the shaft 21, and a polarization plate 29 mounted to the shaft 21 at a portion opposite to the position adjusting portion 26 with respect to the support rod 24. By rotating the position adjusting portion 26 to rotate the shaft 21 about its axis as shown by the arrow in FIG. 8A, the polarization plate 29 can be vertically rotated 180° about the shaft 21 as shown in FIG. 8B.

Accordingly, the polarization plate 29 is moved from the lower side of the shaft 21 to the upper side thereof and the half-wave plate 17b is reversed in position so as to face the right eye of the observer.

While this condition is similar to that shown in FIG. 5B, the difference is such that the half-wave plate 17b is maintained at the right position on the polarization plate 29 during the rotation of the shaft 21.

Although not shown, a label indicating that a 3D image displayed on the image display portion is being observed may be attached to the position adjusting portion 26 in the condition shown in FIG. 8A, whereas a label indicating that the wave plate filter is being adjusted in position may be attached to the position adjusting portion 26 in the condition shown in FIG. 8B (ditto for the following examples).

Further, by rotating the polarization plate 29 as mentioned above to displace the polarization plate 29 aside from the eye position of the observer, the image displayed can be easily switched from a 3D image to a 2D image or vice versa. This switching can be easily performed because the eye position of the observer is unchanged. Further, this configuration shown in FIGS. 8A and 8B is preferable in the point that the adjustment of position of the wave plate filter and the observation of a 2D image can be made without the use of the polarization plate 29 (ditto for the following examples).

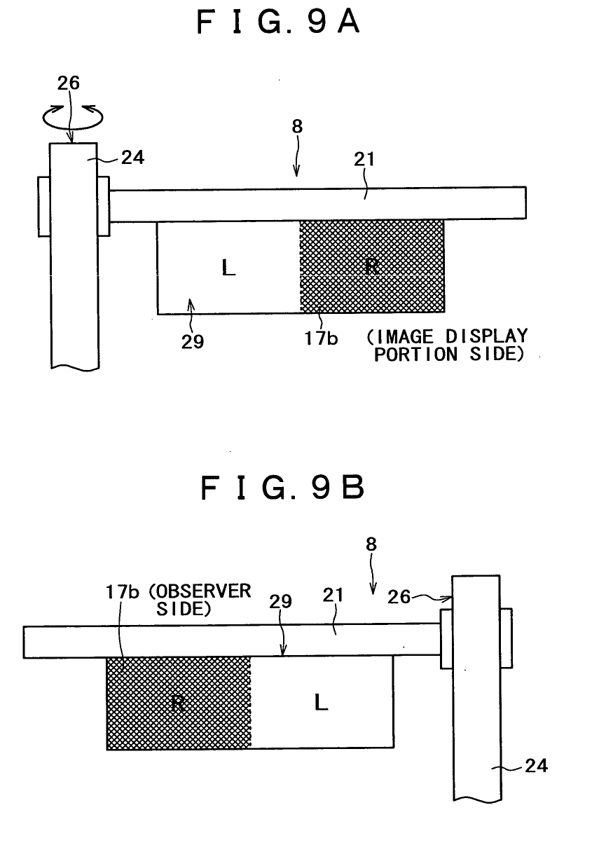

The polarization plate holder 8 shown in FIG. 9A has a vertically extending support rod 24 serving as a position adjusting portion 26, a horizontally extending shaft 21 fixed at its one end to the support rod 24, and a polarization plate 29 mounted to the shaft 21. The support rod 24 is rotatable about its axis. By 180° rotating the support rod 24 about its axis to rotate the shaft 21 as shown by the arrow in FIG. 9A, the polarization plate 29 can be horizontally rotated 180° about the support rod 24 as shown in FIG. 9B.

Accordingly, the polarization plate 29 is moved from the right side of the support rod 24 to the left side thereof and the half-wave plate 17b is reversed in position so as to face the left eye of the observer. This condition is similar to that shown in FIG. 5B with the exception that the position of the polarization plate 29 is different.

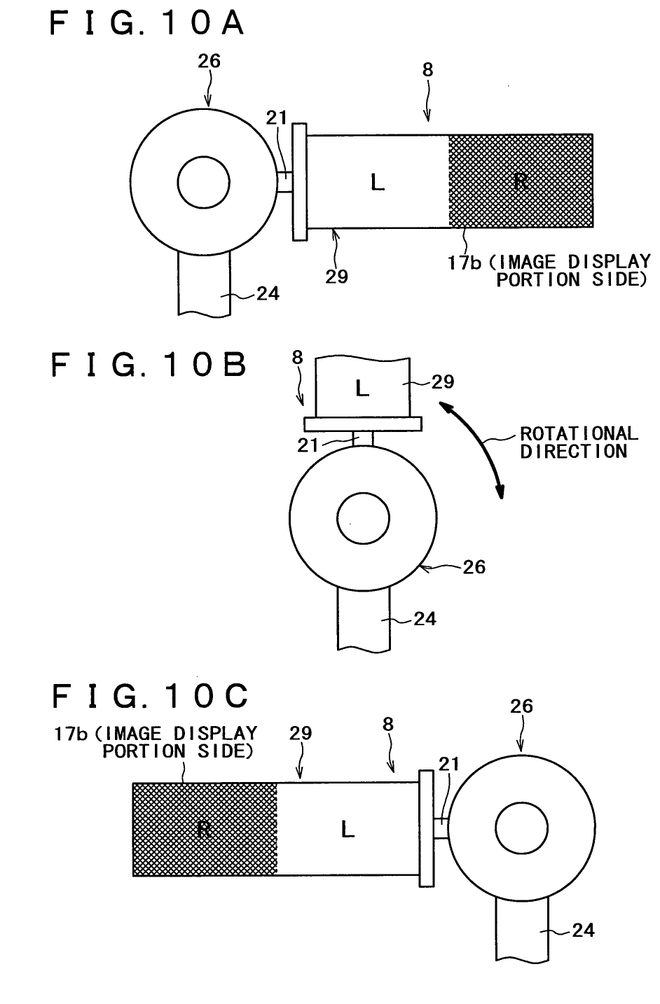

The polarization plate holder 8 shown in FIG. 10A has a vertically extending support rod 24, a position adjusting portion 26 provided at the upper end of the support rod 24 so as to be vertically rotatable (rotatable about a horizontal axis), a connecting shaft 21 fixed at its one end to the position adjusting portion 26, and a polarization plate 29 fixed to the other end of the connecting shaft 21. The half-wave plate 17b is provided on the back side of the right half portion of the polarization plate 29.

By 180° rotating the position adjusting portion 26 as shown by the arrow in FIG. 10B to the condition shown in FIG. 10C, the polarization plate 29 can be moved from the right side of the support rod 24 to the left side thereof. The condition shown in FIG. 10C corresponds to a condition obtained by reversing the right and left half portions of the polarization plate 29 shown in FIG. 5A to the left and right half portions, respectively. This configuration is effective in the case that the right-eye image and the left-eye image are reversed to each other or the positional relation between the filter and the image display portion is prefixed and improperly reversed in horizontal position. Accordingly, by reversing the right and left portions of the polarization plate 29 to the left and right portions, respectively, the image can be properly observed.

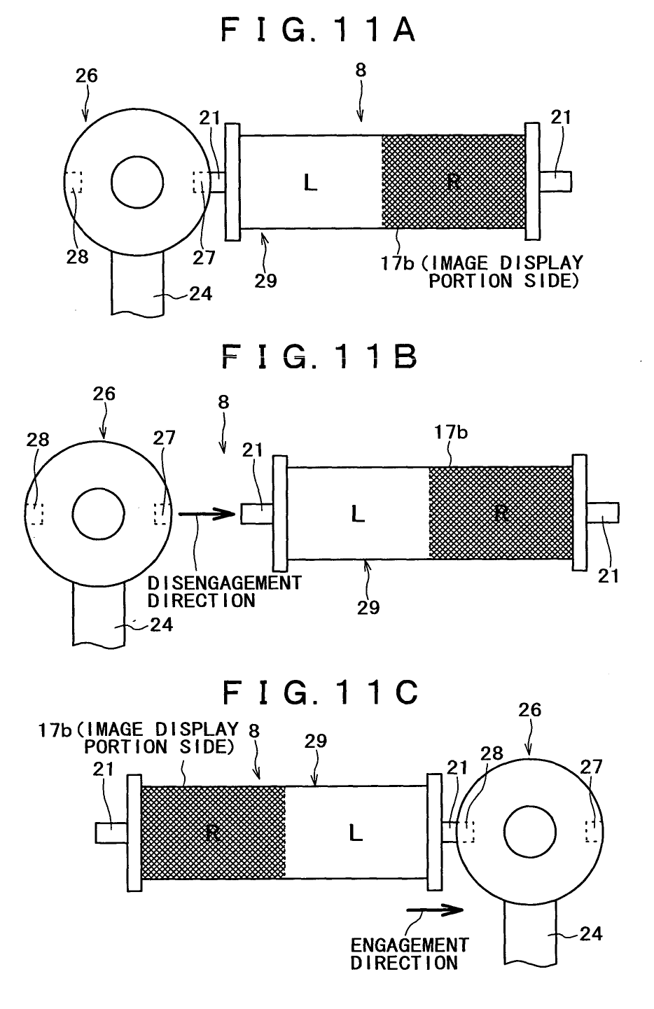

The polarization plate holder 8 shown in FIG. 11A has a vertically extending support rod 24, a position adjusting portion 26 provided at the upper end of the support rod 24 and having a pair of right and left mounting recesses 27 and 28, a pair of right and left connecting shafts 21 removably engageable with the mounting recesses 27 and 28, and a polarization plate 29 connected through the left connecting shaft 21 to the position adjusting portion 26.

By disengaging the left connecting shaft 21 from the right mounting recess 27 of the position adjusting portion 26 to remove the polarization plate 29 from the position adjusting portion 26 as shown in FIG. 11B, next vertically inverting the polarization plate 29 (180° rotating the polarization plate 29 vertically), and next engaging the right connecting shaft 21 into the left mounting recess 28 of the position adjusting portion 26 as shown in FIG. 11C, the polarization plate 29 can be moved from the right side of the support rod 24 to the left side thereof. The condition shown in FIG. 11C corresponds to a condition obtained by reversing the right and left half portions of the polarization plate 29 shown in FIG. 5A to the left and right half portions, respectively. In this condition, the half-wave plate 17b is provided on the back side of the left half portion of the polarization plate 29.

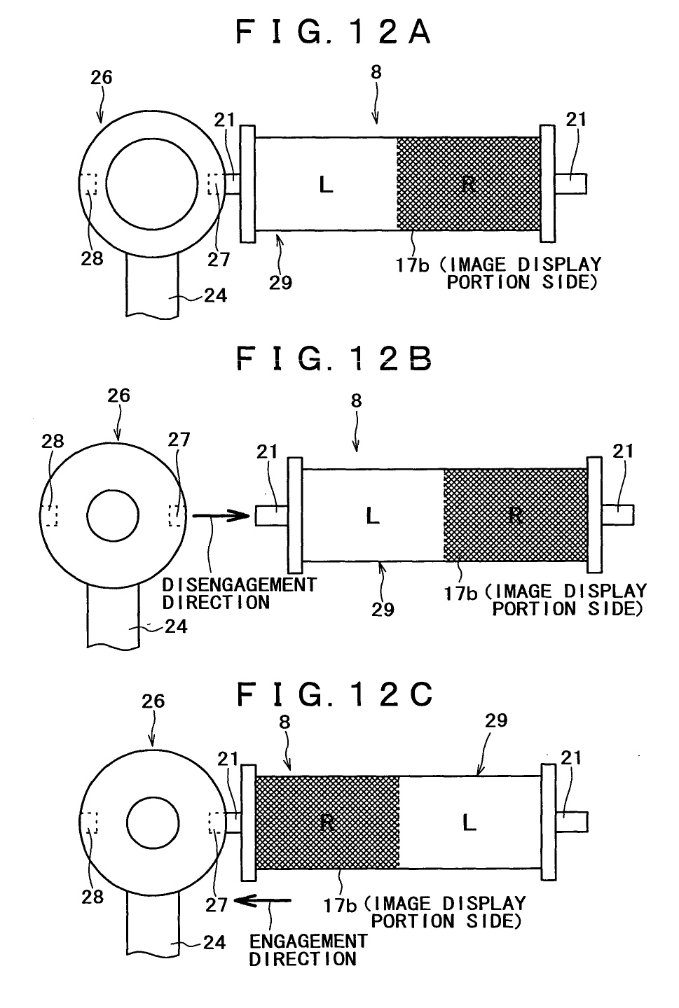

The polarization plate holder 8 shown in FIG. 12A is similar in configuration to that shown in FIG. 11A. The difference is such that after removing the polarization plate 29 from the position adjusting portion 26 as shown in FIG. 12B, the polarization plate 29 is vertically inverted (180° rotated vertically) and the left connecting shaft 21 is engaged into the original right mounting recess 27 of the position adjusting portion 26. With this configuration, the half-wave plate 17b can be changed to the left position on the polarization plate 29 without changing the position of the polarization plate 29.

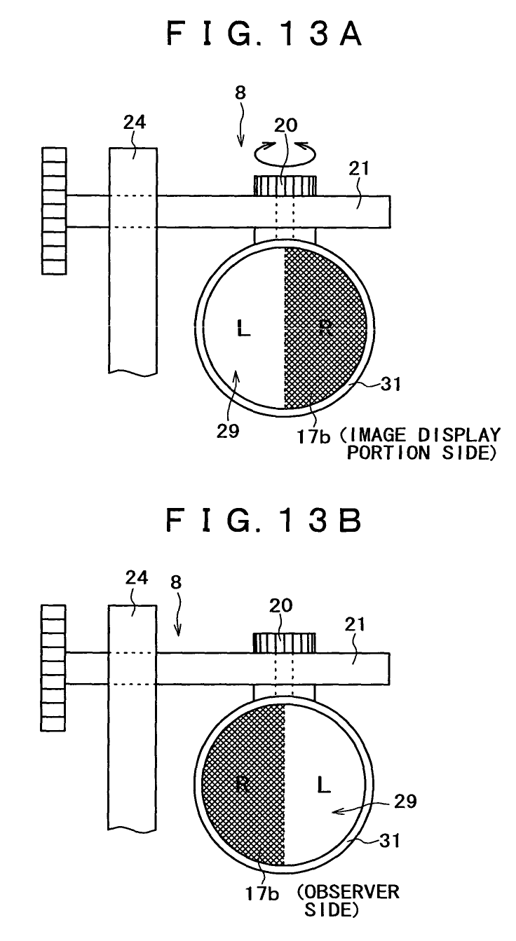

The polarization plate holder 8 shown in FIG. 13A has a vertically extending support rod 24, a horizontally extending shaft 21 fixedly supported to the support rod 24 at right angles thereto, a position adjusting portion 20 rotatably supported to the shaft 21, a ringlike frame 31 connected to the position adjusting portion 20 and adapted to be rotated by the position adjusting portion 20, and a circular polarization plate 29 held within the ringlike frame 31. The half-wave plate 17b is provided on the back side of the semicircular right half portion of the polarization plate 29.

By 180° rotating the polarization plate 29 horizontally about the axis of the position adjusting portion 20 as shown by the arrow in FIG. 13A, the half-wave plate 17b can be reversed in position so as to face the left eye of the observer as shown in FIG. 13B. This condition corresponds to the condition shown in FIG. 5B.

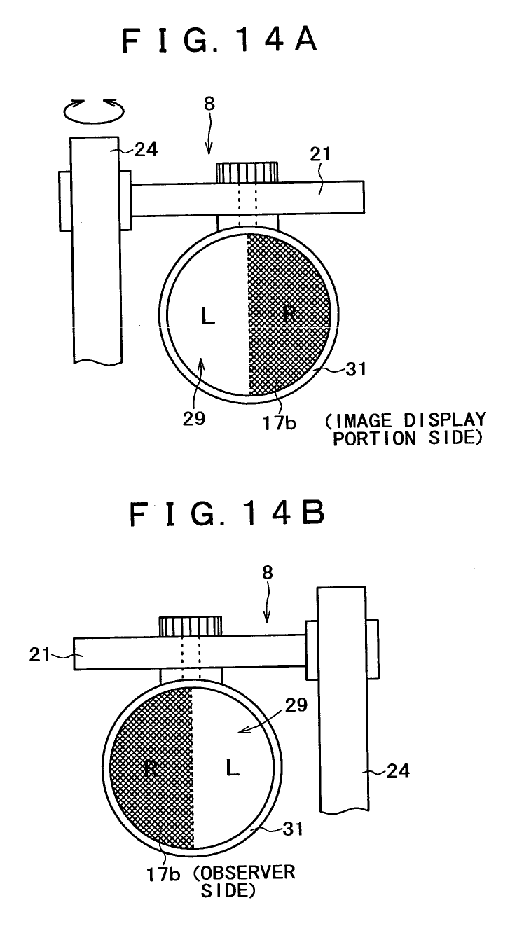

The polarization plate holder 8 shown in FIG. 14A has a vertically extending support rod 24 rotatable about its axis, a horizontally extending shaft 21 fixed at its one end to the support rod 24 to extend at right angles thereto, a ringlike frame 31 fixed to the shaft 21, and a circular polarization plate 29 held within the ringlike frame 31. The half-wave plate 17b is provided on the back side of the semicircular right half portion of the polarization plate 29.

By 180° rotating the polarization plate 29 and the shaft 21 horizontally about the axis of the support rod 24 as shown by the arrow in FIG. 14A, the polarization plate 29 can be moved from the right side of the support rod 24 to the left side thereof, so that the half-wave plate 17b can be reversed in position so as to face the left eye of the observer. This condition is similar to that shown in FIG. 5B with the exception that the position of the polarization plate 29 is different.

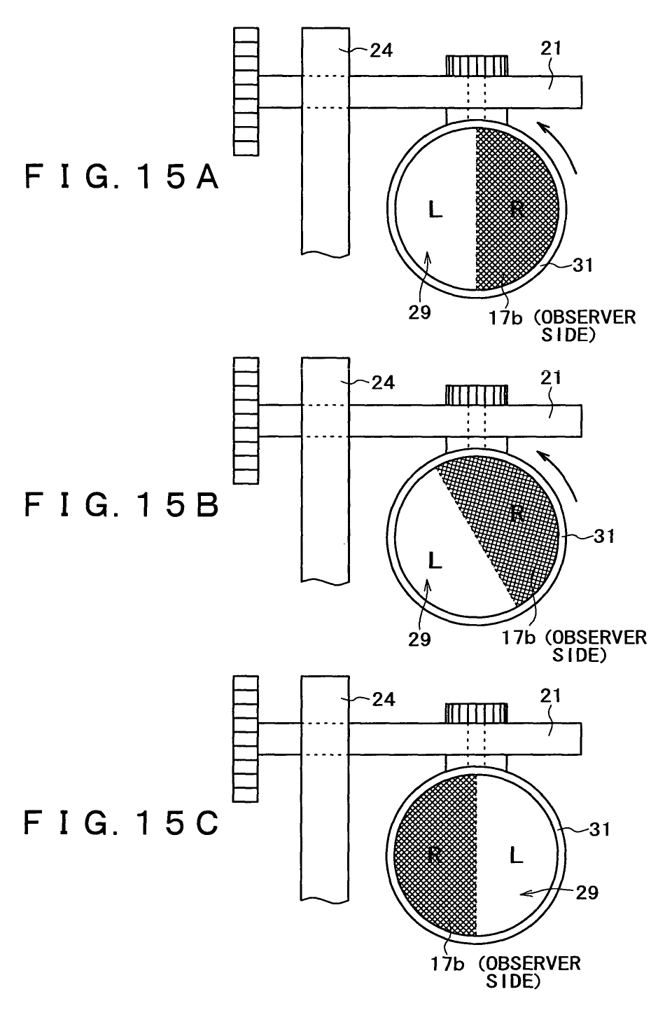

The polarization plate holder 8 shown in FIG. 15A is similar to that shown in FIG. 13A with the exception that the circular polarization plate 29 is slidably held within the ringlike frame 31. That is, the polarization plate 29 is rotatable relative to the frame 31.

By 180° rotating the polarization plate 29 within the ringlike frame 31 as shown by the arrow in FIG. 15B to the position shown in FIG. 15C, the half-wave plate 17b can be brought into an arbitrary inclined condition as shown in FIG. 15B or a horizontally inverted condition shown in FIG. 15C.

As described above, the polarization plate holder 8 has any mechanism for rotating or inverting the polarization plate 29, thereby exhibiting the effect of facilitating the adjustment of position of the wave plate filter. Furthermore, it is also possible to exhibit the effect that the image can be properly observed by reversing the right and left half portions of the polarization plate 29 to the left and right half portions, respectively, in the case that the right-eye image and the left-eye image are reversed to each other or the positional relation between the filter and the image display portion is prefixed and improperly reversed in horizontal position.

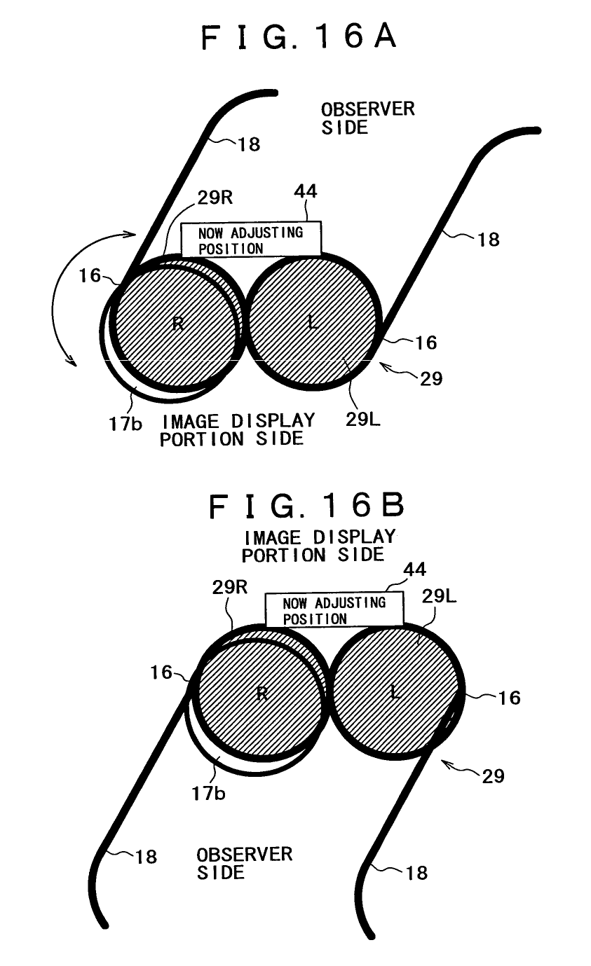

FIGS. 16A and 16B show an application of the structure according to this preferred embodiment to a pair of polarization spectacles as the polarization plate 29.

As shown in FIG. 16A, the polarization spectacles have a pair of temples 18, a pair of polarization plates 29L and 29R having the same polarization angle, and a pair of hinges 16 for pivotably connecting the temples 18 to the polarization plates 29L and 29R in such a manner that the temples 18 can be horizontally rotated about the hinges 16 as shown by the arrow in FIG. 16A. The half-wave plate 17b is provided on the polarization plate 29R so as to face the image display portion. A plate 44 signing “Now Adjusting Position” is provided on the upper ends of the polarization plates 29L and 29R, so that when the polarization spectacles are worn by the observer, the observer can easily determine whether the half-wave plate 17b is located on the right side or the left side.

The polarization spectacles shown in FIG. 16A are used to observe a 3D image displayed on the image display portion as mentioned above with reference to FIG. 4A. By 180° horizontally rotating the temples 18 from the condition shown in FIG. 16A to the condition shown in FIG. 16B, the condition substantially similar to that shown in FIG. 4B can be obtained. In the condition shown in FIG. 16B, the adjustment of position of the half-wave plate 17a (or the separate wave plate filter 14) can be easily performed.

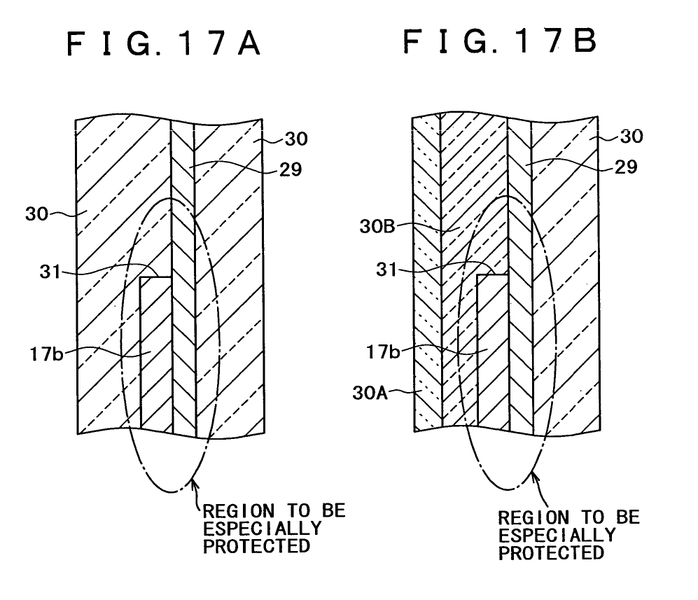

In the structure that the half-wave plate 17b is provided on the half portion of the polarization plate 29, it is preferable to form a pair of transparent protective layers 30 on the opposite surfaces of the assembly of the half-wave plate 17b and the polarization plate 29 bonded together as shown in FIG. 17A. Each protective layer 30 is relatively thick and formed of a material having no birefringence and good in moisture resistance, light resistance, wear resistance, and chemical resistance.

By forming the protective layers 30, a step 31 corresponding to the thickness of the half-wave plate 17b present at the side edge of the half-wave plate 17b (at the central portion of the polarization plate 29) can be eliminated to obtain a flat shape. Furthermore, the polarization plate 29 can be protected from an external shock, wear, etc., thereby suppressing the separation of the half-wave plate 17b. Moreover, a deterioration due to moisture absorption or the like can be eliminated. In addition, it is possible to reduce refraction or scattering of light between the polarization plate 29 and the half-wave plate 17b due to the step 31.

The material of each protective layer 30 may be selected from transparent resins such as acrylic resins (e.g., PMMA), polycarbonate, and polypropylene, and soft rubber materials such as transparent silicone rubber. Such a protective layer may be formed by various methods including a method of sufficiently filling the material in the state of monomer or oligomer and irradiating the material with light such as ultraviolet (UV) rays to thereby cure the material, a method of mixing two components of the material to polymerize the mixture, and a method of evaporating a solvent dissolving the material. In these processes, however, the phase difference plate and the polarization plate must not be damaged. The protective layers 30 may be formed by dipping, coating, or casting, wherein it is important to flatten the surface of each layer 30. If the surface of each layer 30 has roughness, a lens is produced by the rough surface, causing a deterioration in field of view.

FIG. 17B shows a modification of the protective layers 30. In this modification, a transparent adhesive layer 30B having a relatively large thickness is formed on a flat transparent film 30A having no birefringence to prepare a transparent protective layer 30, and the polarization plate 29 with the half-wave plate 17b is attached to this transparent protective layer 30. Another protective layer 30 similar to that shown in FIG. 17A is formed on the back surface of the polarization plate 29 opposite to the half-wave plate 17b. Also in this modification, the step 31 produced at the side edge of the half-wave plate 17b can be covered by the thickness of the adhesive layer 30B.

The material of the flat transparent film 30A as a protective film may be selected from triacetyl cellulose (TAC), low-birefringence polycarbonate, acrylic polymers, norbornene polymers, or vinyl ester polymers, for example. The transparent adhesive layer 30B may be formed of triacetyl cellulose or a composite adhesive material of acrylic resins, for example. The transparent adhesive layer 30B may be formed by casting, printing, etc. Further, the thickness of the adhesive layer 30B may be increased by applying UV-curing type resin several times.

The protective layer 30 on the half-wave plate 17b side is so formed as to preferably cover at least the side edge of the half-wave plate 17b at the central portion of the polarization plate 29 and the entire surface of the half-wave plate 17b exposed to the air. However, the other protective layer 30 on the back surface of the polarization plate 29 opposite to the half-wave plate 17b may be omitted.

Other modifications may be made within the scope of the present invention.

For example, the sizes, shapes, structures, materials, etc. of the polarization plates 19 and 29, the position adjusting portions 3 and 5, and the arm 4 may be arbitrarily selected. Further, the angles of adjustment of the position adjusting portions 3 and 5 in the vertical, lateral, and longitudinal directions may be arbitrarily changed, and the mounting position of the polarization plate holder 8 to the frame 35 may also be arbitrarily changed.

Further, the polarization plate holder 8 may be mounted not only to the notebook computer 10 having the movable image display portion 34, but also to a desktop computer, television set, projector screen, etc. Further, the polarization plate holder 8 may be mounted also at any place such as a desk other than the image display portion. The polarization plate holder 8 may be detachably mounted through the above-mentioned mounting structure to the image display portion or any other portions, or may be kept fixed.

Further, the polarization plate 19 removed from the polarization plate holder 8 may be stored into a PC card slot 47 formed in the notebook computer 10 shown in FIG. 2A. Further, when the polarization plate holder 8 is not used, the polarization plate 19 may be rotated toward the arm 4, or the arm 4 may be stored into a storing portion (not shown) formed in the frame 35.

While the position adjusting operation of the position adjusting portions 3 and 5 and the extension/contraction operation of the arm 4 in the polarization plate holder 8 are manually performed in the above preferred embodiments, these operations may be performed mechanically and automatically by motor drive or the like.

Further, while the liquid crystal panel 9 is adopted as the image display portion in the above preferred embodiments, any other types of image display devices such as a light emitting element array display device, organic electroluminescent display device, cathode ray tube, and plasma display device may be used.

While the separate wave plates are arrayed at intervals of one pixel line so as to extend horizontally, the separate wave plates may extend vertically or obliquely according to the pattern of the pixel portions. Further, the separate wave plates may be configured in the form of dots or islands rather than lines. Further, while the separate wave plates are formed on the surface of the transparent support substrate opposed to the liquid crystal panel 9, the separate wave plates may be formed on the other surface of the support substrate opposed to the observer.

Further, while the position adjusting portion 5 or the like for changing the position of the polarization plate 19 or the like as the polarization means by rotation or the like is provided on the arm 4 of the polarization plate holder 8, the position adjusting portion may be provided on the polarization means and the arm 4 may be connected to the position adjusting portion.

While the invention has been described with reference to specific embodiments, the description is illustrative and is not to be construed as limiting the scope of the invention. Various modifications and changes may occur to those skilled in the art without departing from the spirit and scope of the invention as defined by the appended claims.

What is claimed is:

1. A three-dimensional image display device comprising:
an image display portion for displaying image information according to a parallax separately in a first segment and a second segment,
polarization direction converting means opposed to said first and second segments of said image display portion for converting a polarization direction of polarized light of said image information from said first segment into a direction different from a polarization direction of polarized light of said image information from said second segment,
polarization means having a first polarization plate portion and a second polarization plate portion to which said polarized lights separated by said polarization direction converting means are respectively input, and
a position holding mechanism for holding the positional relation between said polarization means and said polarization direction converting means.

2. The three-dimensional image display device according to claim 1, wherein said polarization direction converting means comprises a separate wave plate filter, said polarized lights separated by said separate wave plate filter being respectively input into said first polarization plate portion and said second polarization plate portion.

3. The three-dimensional image display device according to claim 2, wherein said separate wave plate filter comprises a half-wave plate, said three-dimensional image display device further having a quarter-wave plate interposed between said image display portion and said polarization means.

4. The three-dimensional image display device according to claim 2, wherein said separate wave plate filter comprises a half-wave plate, said three-dimensional image display device further having a half-wave plate provided on one of said first and second polarization plate portions of said polarization means so as to face said image display portion.

5. The three-dimensional image display device according to claim 4, wherein said first and second polarization plate portions are changeable in position, so that said image information displayed on said image display portion can be changed from a three-dimensional image to a two-dimensional image or vice versa.

6. The three-dimensional image display device according to claim 1, wherein the distance, parallelism, and alignment between said polarization means and said polarization direction converting means are held by said position holding mechanism.

7. The three-dimensional image display device according to claim 1, wherein said position holding mechanism comprises an arm having a first end for supporting said polarization means and a second end fixed to a frame of said image display portion.

8. The three-dimensional image display device according to claim 7, wherein said position holding mechanism further comprises click type position adjusting means provided at said first end of said arm for adjusting the position of said polarization means.

9. The three-dimensional image display device according to claim 7, wherein said position holding mechanism further comprises click type position adjusting means provided at said second end of said arm for adjusting the position of said arm.

10. The three-dimensional image display device according to claim 5 or 7, wherein said position holding mechanism comprises position adjusting means for changing the position of said polarization means or said arm in at least one of a longitudinal direction, a lateral direction, and a vertical direction.

11. The three-dimensional image display device according to claim 10, wherein said polarization means is rotatable relative to said polarization direction converting means in at least one of said longitudinal direction, said lateral direction, and said vertical direction.

12. The three-dimensional image display device according to claim 7, wherein said arm is extendable and contractable in its longitudinal direction.

13. The three-dimensional image display device according to claim 1, wherein said image display portion is adjustable in angular position.

14. The three-dimensional image display device according to claim 1, wherein the surface of said polarization means is covered with a transparent protective material.

15. A position holding mechanism for holding the positional relation between polarization means and polarization direction converting means,
said polarization means having a first polarization plate portion and a second polarization plate portion to which polarized lights separated by said polarization direction converting means are respectively input.

16. The position holding mechanism according to claim 15, wherein said position holding mechanism is for use with a three-dimensional image display device having an image display portion for displaying image information according to a parallax separately in a first segment and a second segment, said polarization direction converting means opposed to said first and second segments of said image display portion for converting a polarization direction of polarized light of said image information from said first segment into a direction different from a polarization direction of polarized light of said image information from said second segment.

17. The position holding mechanism according to claim 15, wherein said polarization direction converting means comprises a separate wave plate filter, said polarized lights separated by said separate wave plate filter being respectively input into said first polarization plate portion and said second polarization plate portion.

18. The position holding mechanism according to claim 17, wherein said separate wave plate filter comprises a half-wave plate, said three-dimensional image display device further having a quarter-wave plate interposed between said image display portion and said polarization means.

19. The position holding mechanism according to claim 17, wherein said separate wave plate filter comprises a half-wave plate, said three-dimensional image display device further having a half-wave plate provided on one of said first and second polarization plate portions of said polarization means so as to face said image display portion.

20. The position holding mechanism according to claim 19, wherein said first and second polarization plate portions are changeable in position, so that said image information displayed on said image display portion can be changed from a three-dimensional image to a 2D image or vice versa.

21. The position holding mechanism according to claim 15, wherein the distance, parallelism, and alignment between said polarization means and said polarization direction converting means are held by said position holding mechanism.

22. The position holding mechanism according to claim 15, wherein said position holding mechanism comprises an arm having a first end for supporting said polarization means and a second end fixed to a frame of said image display portion.

23. The position holding mechanism according to claim 22, wherein said position holding mechanism further comprises click type position adjusting means provided at said first end of said arm for adjusting the position of said polarization means.

24. The position holding mechanism according to claim 22, wherein said position holding mechanism further comprises click type position adjusting means provided at said second end of said arm for adjusting the position of said arm.

25. The position holding mechanism according to claim 20 or 22, wherein said position holding mechanism comprises position adjusting means for changing the position of said polarization means or said arm in at least one of a longitudinal direction, a lateral direction, and a vertical direction.

26. The position holding mechanism according to claim 25, wherein said polarization means is rotatable relative to said polarization direction converting means in at least one of said longitudinal direction, said lateral direction, and said vertical direction.

27. The position holding mechanism according to claim 22, wherein said arm is extendable and contractable in its longitudinal direction.

28. The position holding mechanism according to claim 15, wherein said image display portion is adjustable in angular position.

29. The position holding mechanism according to claim 15, wherein the surface of said polarization means is covered with a transparent protective material.

30. Polarization means comprising:
a first polarization plate portion, and
a second polarization plate portion;
said first and second polarization plate portions are input polarized lights separated by polarization direction converting means, respectively,
said polarization means is mounted to a position holding mechanism for holding the positional relation between said polarization means and said polarization direction converting means.

31. The polarization means according to claim 30, wherein said polarization means is for use with a three-dimensional image display device having an image display portion for displaying image information according to a parallax separately in a first segment and a second segment, and said polarization direction converting means opposed to said first and second segments of said image display portion for converting a polarization direction of polarized light of said image information from said first segment into a direction different from a polarization direction of polarized light of said image information from said second segment.

32. The polarization means according to claim 30, wherein said polarization direction converting means comprises a separate wave plate filter, said polarized lights separated by said separate wave plate filter being respectively input into said first polarization plate portion and said second polarization plate portion.

33. The polarization means according to claim 32, wherein said separate wave plate filter comprises a half-wave plate, said three-dimensional image display device further having a quarter-wave plate interposed between said image display portion and said polarization means.

34. The polarization means according to claim 32, wherein said separate wave plate filter comprises a half-wave plate, said three-dimensional image display device further having a half-wave plate provided on one of said first and second polarization plate portions of said polarization means so as to face said image display portion.

35. The polarization means according to claim 34, wherein said first and second polarization plate portions are changeable in position, so that said image information displayed on said image display portion can be changed from a three-dimensional image to a 2D image or vice versa.

36. The polarization means according to claim 30, wherein the distance, parallelism, and alignment between said polarization means and said polarization direction converting means are held by said position holding mechanism.

37. The polarization means according to claim 36, wherein said position holding mechanism comprises an arm having a first end for supporting said polarization means and a second end fixed to a frame of said image display portion.

38. The polarization means according to claim 36, wherein said position holding mechanism further comprises click type position adjusting means provided at said first end of said arm for adjusting the position of said polarization means.

39. The polarization means according to claim 37, wherein said position holding mechanism further comprises click type position adjusting means provided at said second end of said arm for adjusting the position of said arm.

40. The polarization means according to claim 35 or 37, wherein said position holding mechanism comprises position adjusting means for changing the position of said polarization means or said arm in at least one of a longitudinal direction, a lateral direction, and a vertical direction.

41. The polarization means according to claim 40, wherein said polarization means is rotatable relative to said polarization direction converting means in at least one of said longitudinal direction, said lateral direction, and said vertical direction.

42. The polarization means according to claim 30, wherein the surface of said polarization means is covered with a transparent protective material.
